(19) United States
(12) Patent Application Publication
(10) Pub. No.: US 2024/0301667 A1
(43) Pub. Date: Sep. 12, 2024

(54) A WATER CONSUMER SYSTEM HAVING A WATER CONSUMER, AND METHOD FOR OPERATING A WATER CONSUMER SYSTEM

(71) Applicants: Caroma Industries Limited, New South Wales (AU); micas AG, Oelsnitz (DE)

(72) Inventors: Stephen John Cummings, New South Wales (AU); Michael Fritzsche, Neukirchen/Erzgebirge (DE); Mark Ebert, Oelsnitz/Erzgebirge (DE)

(21) Appl. No.: 18/546,409

(22) PCT Filed: Mar. 15, 2022
(86) PCT No.: PCT/AU2022/050219

§ 371 Date: Aug. 14, 2023

(30) Foreign Application Priority Data
Mar. 15, 2021 (AU) 2021900738

(51) Int. Cl. E03B 7/07; E03D 5/10

(52) U.S. Cl. CPC E03B 7/075; E03B 7/071; E03B 7/072; E03D 5/105; E03F 2201/40

(57) ABSTRACT

A water consumer system comprising a water consumer that comprises a water receptacle, the water consumer system further comprising a fluid inlet with an inlet valve, a fluid outlet, at least one HF motion sensor for detecting fluid motion provided on the water receptacle and/or at the fluid outlet and a water consumer controller coupled with the HF motion sensor and the inlet valve, wherein the water consumer controller comprises a data processing system, which is arranged to Retrieve or receive data captured by the HF motion sensor, to evaluate the data arithmetically and, based on the evaluated data, to detect one of the following malfunctions or initiate an action, in order to prevent one out of the variety of the following malfunctions, such as that the outlet is obstructed, there is a pressure fluctuation in a wastewater system, the fluid inlet is malfunctioning, etc.

### TECHNICAL FIELD

The present invention relates to a water consumer system having a water consumer having a water receptacle, a fluid inlet with an inlet valve, a fluid outlet, at least one HF motion sensor provided on the water receptacle and/or the fluid outlet, and a water consumer controller coupled to the at least one HF motion sensor and to the inlet valve. The present invention also relates to a water consumer system having a water consumer according to the invention. In addition, the invention relates to a method for operating a water consumer system having a water receptacle, a fluid inlet with an inlet valve, a fluid outlet, at least one HF motion sensor provided on the water receptacle and/or the fluid outlet, and a water consumer controller coupled to the at least one HF motion sensor and to the inlet valve, by means of which the inlet valve is opened for a predetermined time when the at least one HF motion sensor detects draining fluid.

### BACKGROUND

Particularly in public facilities such as theaters, sports facilities, restaurants, shopping malls, airports, schools and universities, as well as in larger office complexes and similar high-traffic buildings, various water consumers (e.g. sinks, toilet bowls, cisterns, baths, showers etc.) may be equipped with automatic and contactless water process due to the large number of users. For example, the water process may be a toilet bowl flush, cistern fill, sink, shower or bath usage (from activating one or more connected taps, faucets or showerheads). Different sensor methods can be used to detect the water usage. With high traffic, obstructions or other malfunctions of the water consumer can often occur, which are often only recognized very late by a user or through regular maintenance and which, until they are recognized, can lead to unnecessarily high water consumption or insufficient cleaning of the water consumer.

Document EP 1 586 713 A1 addresses a device and a method for automatically triggering a flushing device by means of a capacitive sensor, the device having a water seal which has an inlet, an outlet and an overflow edge. A capacitive sensor with at least one electrode is arranged on an outside of the water seal. The at least one electrode is arranged in front of the overflow edge in the region of the surface of the sealing water, seen in the direction of flow.

A sanitary system with a central mixing control is known from the document EP 2 649 246 B1, which is connected on the inlet side to a hot water line and a cold water line and on the outlet side to a plurality of mixed lines leading to consumers. The sanitary system uses a control center that controls a controllable mixing unit based on parameter values such as temperature, pressure, flow rate and/or flow quantity. Appropriate sensors are provided for determining the parameter values.

Document WO 2009/061857 A2 proposes a method for automatically generating work orders for a toilet, whereby not only states of a large number of device sensors, but also states of a non-device sensor are captured and these states are used to determine the state of a device, which has no sensor. In particular, the need for replenishing consumables is calculated.

In the document US 2011/0114202 A1, a valve in a water supply line is closed by means of a control when an unusual water flow rate is detected by a sensor located in the water supply line, and is opened again after a waiting period.

The immediate detection of a malfunction of a water consumer and/or the correct assignment of a malfunction of a water consumer to a specific cause is often problematic. For example, when the water consumer is operated, the water flowing from the fluid inlet via the water receptacle to the fluid outlet passes the fluid outlet after a certain delay. In some water consumer systems, such a delay can be caused, for example, by a hydraulic delay in the inlet valve, the path to be covered by hoses/pipes between the inlet valve and the fluid inlet, or by reservoir devices. However, a malfunctioning inlet valve or an at least partially obstructed fluid outlet can also lead to delays. With known water consumer systems, the specific cause of the problem can usually only be determined by a sanitary technician or service employee, despite the sensors used.

### SUMMARY

It is an object of the present invention to substantially overcome, or at least ameliorate, one or more disadvantages of existing arrangements.

The object is achieved on the one hand by a water consumer system having a water consumer having a water receptacle, a fluid inlet with an inlet valve, a fluid outlet, at least one HF motion sensor for detecting fluid motion provided on the water receptacle and/or the fluid outlet, and a water system controller coupled with the at least one HF motion sensor and the inlet valve, wherein the water system controller has a data processing system and/or is connected to a data processing system which is designed to retrieve and/or receive data captured by at least one HF motion sensor, to evaluate it computationally and, based on the evaluated data, to detect at least one of the following malfunctions, and/or initiate at least one action in order to avoid at least one of the following malfunctions:
that the fluid outlet is obstructed, and/or
that there is a pressure fluctuation in a wastewater system connected to the water consumer system, and/or
that the fluid inlet and/or the inlet valve is/are malfunctioning, and/or
that at least one of the at least one HF motion sensors has failed,
   and/or to recognize a predefined water consumer usage situation and/or frequency of use on the basis of the evaluated data and, on the basis thereof, to adapt an opening time and/or an opening position and/or an opening frequency of the inlet valve in at least one subsequent water consumer water process, wherein the water consumer is one of a sink, toilet bowl, cistern, shower, and bath.

Different water consumer water processes may be performed depending on the type of water consumer. For example, a water consumer process may be a process such as, opening a water inlet valve for a tap (to allow water to enter a water receptacle in the form of a sink bowl (i.e. part of a water consumer that is a sink) or a bath tub (i.e. part of a water consumer that is a bath)), opening a water inlet valve for a shower head (to allow water to enter a water receptacle in the form of a shower unit (i.e. part of a water consumer that is a shower)), opening a water inlet valve for a cistern (to allow water to enter a water receptacle in the form of a cistern unit (i.e. part of a water consumer that is a cistern)).

The water consumer system according to an embodiment of the invention can have a water receptacle or a plurality of water receptacles.

The at least one HF motion sensor is preferably arranged on the water receptacle and/or the fluid outlet in such a way that it can detect flowing fluids in the region of a drain of the water receptacle. The at least one HF motion sensor is preferably arranged on the rear side of the water receptacle in the immediate spatial vicinity of the fluid outlet. In particular, the at least one HF motion sensor itself or at least one holding device comprising the at least one HF motion sensor is glued, bolted, or otherwise fastened to the rear of the water receptacle.

The at least one HF motion sensor preferably does not point in the direction of a sealing water in an odor trap of the fluid outlet. The arrangement and alignment of the motion sensor advantageously ensures that it is able to detect the water flowing from the fluid inlet to the fluid outlet during a water consumer water process and/or the fluid hitting and/or flowing out of the water receptacle when the water consumer system is used.

The data acquired by the at least one HF motion sensor are retrieved and/or received by the data processing system contained in the water system controller or connected to it. The data is preferably transmitted via a wireless or mesh data transmission network, such as via Bluetooth, for example, and particularly preferably via Bluetooth mesh. This advantageously enables communication with a mobile device, which has the advantage of a simplified operating function and simple setting and diagnosis options. It is also advantageous that communication with a building control via a cloud or a building management system is made possible, which in particular simplifies the retrieving of operating data or the display of service requirements. Another advantage of data transmission using a wireless or mesh data transmission network is the ability to communicate with other sensor products either directly in a network or indirectly via at least one gateway.

The data processing system has either predetermined reference values or, after a certain period of use of the water consumer system, empirical values and/or its own operating data, for example with regard to the usual draining times associated with a water consumer water process. Deviations from the reference values and/or empirical values are registered and at least one action is triggered to prevent the cause of the deviation. In addition to the operating data of a single HF motion sensor, the data processing system can also receive data from other sensors, such as, for example, from pressure and/or flow sensors in a water supply system and/or a wastewater disposal system of the water consumer system, or from a building control.

A possible action to be triggered by the data processing system can be, for example, adapting the opening time and/or the opening position and/or the opening frequency of the inlet valve and/or sending an error message and/or a service message.

The inlet valve can, for example, be a solenoid valve with a defined opening time and/or opening position and/or opening frequency, which is activated by the water system controller.

If the fluid outlet is obstructed, fluid accumulates in the water receptacle. If the sensor region of the water receptacle is completely filled with fluid, the at least one HF motion sensor typically no longer detects any water flow, since the HF motion sensor can usually not penetrate the fluid. In this situation, the data processing system no longer recognizes use and does not trigger a new water consumer water process, such as a toilet bowl flush—that is to say, the inlet valve does not open again. In addition to reducing the opening frequency of the inlet valve to zero, an obstruction can be reported to a mobile device or a building control.

Alternatively, a sensory detection of the obstruction is also possible in that the HF motion sensor not only detects the motion in the water receptacle, but can also distinguish between empty water receptacles and, for example, filled water receptacles, at least up to a marking. A signal analysis of the HF motion sensor is preferably carried out for this purpose. The strong reflection in the vicinity of the HF motion sensor leads to changed signal levels, even if the water receptacle is full-such as a shift in the offset voltage of the HF motion sensor. This effect arises from a change in the phase position of the reflected signal from the HF motion sensor, due to the distance and/or material properties of the reflecting standing fluid in the vicinity of the HF motion sensor.

Alternatively, a standing fluid within the water receptacle can be detected with the aid of another sensor method. In particular, another HF motion sensor method suitable for detecting static objects can be used, for example using at least one frequency modulated continuous wave radar (FMCW), at least one capacitive sensor and/or at least one other suitable sensor or sensor system.

The malfunction that the fluid outlet is obstructed, which is to be avoided according to an embodiment of the invention using the data processing system, includes a partial or beginning obstruction, as well as a complete obstruction of the fluid outlet.

If an obstruction is starting to form, the draining times at or in the fluid outlet are extended, as a result of which the HF motion sensor registers longer-lasting motion and/or a lower flow rate. A deviation of the draining times from empirical and/or reference values that are preferably stored, but can also be input, is recognized (or determined) by the data processing system and leads to an error message and/or service message being sent.

The data processing system is advantageously able to recognize (or determine) when no running water is registered by the HF motion sensor after a water process has taken place. Advantageously in this case, on the one hand, no further water process is triggered until a new motion is detected; on the other hand, an error message and/or a service message is preferably sent.

In the event of a pressure fluctuation in a wastewater system connected to the water consumer system, for example due to an improper or malfunctioning installation, such as insufficient ventilation of the wastewater pipe, strong pressure fluctuations occur during a water process, which can lead to fluctuating water levels in the water seal or even emptying. If such a fluctuation is sensed as a motion by the HF motion sensor, incorrect water processes can be triggered. The data processing system preferably recognizes a motion triggered by a fluctuating water level as such and does not trigger a new water process. One possible action is sending an error message and/or a service message and/or preventing a new water process. Such a faulty motion signal can be detected by a signal analysis with reference to the signal profile of the typical sensor signals, which, as explained above, can be based on empirical values and/or reference values. These oscillations of this signal profile should settle down during a regular water process.

In the event of a malfunction in the fluid inlet, it may be that the HF motion sensor no longer registers any motion because the valve does not open and no fluid flows, that the HF motion sensor permanently registers motion because the valve does not close completely, or that the HF motion sensor registers a reduced amount of fluid because the valve only opens incompletely and only a reduced amount of water is released during the flushing process (i.e. the water consumer water process). The action triggered by the data processing system is then advantageously the sending of an error message and/or a service message.

If the HF motion sensor registers a permanent flow of fluid, the water supply of the water consumer system can be interrupted according to an embodiment of the invention by activating a shut-off valve, preferably via a wireless or mesh data transmission network-such as, for example, via Bluetooth or Bluetooth mesh.

It is particularly advantageous if the water system controller activates the at least one HF motion sensor permanently or at a certain predetermined time interval with pulses. If at least one of the at least one HF motion sensors fails, the data processing system detects a lack of response to the pulses and sends an error message and/or service message.

The data processing system is preferably designed to recognize (or determine) a predefined water consumer usage situation and/or frequency of use on the basis of the evaluated data and, based on this, to adapt an opening time and/or an opening position and/or an opening frequency of the inlet valve in at least one subsequent water consumer water process.

In this way, for example, times of high traffic can advantageously be identified, and suitable and effective water-saving programs activated for the given situation. For example, a flushing interval and/or a flushing volume can be adapted to a predicted number of users of the water consumer system and, for example, a cleaning flushing can be triggered at suitable times with an increased flushing volume compared to the regular flushing process.

The water consumer system preferably also has at least one pressure sensor and/or at least one flow sensor in the fluid inlet, and/or is coupled to at least one pressure sensor and/or at least one flow sensor in the fluid inlet via a mesh and/or wireless local data transmission network.

Advantageously, by combining the signals of at least one of the at least one HF motion sensors with the signals of the at least one pressure sensor and/or of the at least one flow sensor, a distinction can be made between different situations that lead to the same or similar reactions of at least one of the at least one HF motion sensors. The absence of a reaction of at least one of the at least one HF motion sensors to a previously triggered flushing can be attributed, for example, to the fact that a complete obstruction is present, and due to this, at least one of the at least one HF motion sensors is blind, to the fact that the inlet valve is not opening due to a valve malfunction or an electronics defect, or to the fact that there is a malfunction in the water supply.

The at least one pressure sensor in the fluid inlet is expediently able to detect whether there is a water supply, while the at least one flow sensor in the fluid inlet is able to detect whether water is flowing out of the fluid inlet or not. The corresponding situations can be recognized and distinguished from each other based on typical signal profiles of at least one of the at least one HF motion sensors in conjunction with data from the at least one pressure sensor and/or the at least one flow sensor in the fluid inlet, by means of a classifier or another suitable AI algorithm—that is, an algorithm using artificial intelligence.

The object is also achieved by a water consumer system having a water receptacle, a fluid inlet with an inlet valve, a fluid outlet, at least one HF motion sensor for detecting fluid motion provided on the water receptacle and/or the fluid outlet, and a water system controller coupled to the at least one HF motion sensor and the inlet valve, wherein the water consumer system also has at least one pressure sensor and/or at least one flow sensor in the fluid inlet, and/or is coupled to at least one pressure sensor and/or at least one flow sensor in the fluid inlet via a mesh data transmission network, and the water system controller has a data processing system, and/or is connected to a data processing system, which is designed to retrieve and/or receive data captured by at least one HF motion sensor and/or the at least one pressure sensor and/or the at least one flow sensor, to evaluate the same electronically, and to recognize (or determine) at least one of the following malfunctions on the basis of the evaluated data and/or to trigger at least one action in order to avoid at least one of the following malfunctions:
that the fluid outlet is obstructed, and/or
that there is a pressure fluctuation in a wastewater system connected to the water consumer system, and/or
that the pressure in the fluid inlet has dropped below a minimum pressure value, or has exceeded a maximum pressure value, and/or
that the inlet valve is malfunctioning, and/or
that at least one of the at least one HF motion sensors has failed,
   and/or to recognize (or determine) a predefined water consumer usage situation and/or frequency of use on the basis of the evaluated data and, on the basis thereof, to adapt an opening time and/or an opening position and/or an opening frequency of the inlet valve in at least one subsequent water consumer water process, wherein the water consumer is one of a sink, toilet bowl, cistern, shower or bath.

Different water consumer water processes may be performed depending on the type of water consumer. For example, a water consumer process may be a process such as, opening a water inlet valve for a tap (to allow water to enter a water receptacle in the form of a sink bowl (i.e. part of a water consumer that is a sink) or a bath tub (i.e. part of a water consumer that is a bath)), opening a water inlet valve for a shower head (to allow water to enter a water receptacle in the form of a shower unit (i.e. part of a water consumer that is a shower)), opening a water inlet valve for a cistern (to allow water to enter a water receptacle in the form of a cistern unit (i.e. part of a water consumer that is a cistern)

The water consumer system according to an embodiment of the invention can have a water receptacle or a plurality of water receptacles.

The at least one HF motion sensor is preferably arranged on a rear side of the water receptacle in the immediate spatial vicinity of the fluid outlet. The at least one HF movement sensor preferably does not point in the direction of a sealing water in the odor trap of the water consumer drain.

Fluids flowing in and out in the region of the fluid outlet can be detected with the at least one HF motion sensor. The at least one HF motion sensor itself can be glued, screwed or otherwise fastened to the rear of the water receptacle, or by means of at least one holding device having or holding the at least one HF motion sensor.

The arrangement and alignment of the motion sensor advantageously ensures that it is able to detect the motion of the flush water flowing from the fluid inlet to the fluid outlet during a water consumer water process, and/or of the fluid hitting and/or flowing out of the water receptacle when the water consumer system is used.

The water consumer system according to an embodiment of the invention also has at least one pressure sensor and/or at least one flow sensor in the fluid inlet and/or is coupled to at least one pressure sensor and/or at least one flow sensor in the fluid inlet via a mesh network and/or a wireless local data transmission network.

The at least one pressure sensor in the fluid inlet advantageously detects whether there is a water supply, while the at least one flow sensor in the fluid inlet detects whether water is flowing out of the fluid inlet or not.

If the at least one pressure sensor reports the presence of a water supply at the same time as the at least one HF motion sensor does not register any flow motion during a flushing process, it is likely that either a complete obstruction is present, or a valve malfunction or an electronics malfunction has made it so that the inlet valve does not open. If the at least one flow sensor in the fluid inlet reports that water is flowing out of the fluid inlet during a flushing process, at the same time as the at least one HF motion sensor does not register any flow motion, the data processing system will assume complete obstruction as the most likely scenario.

Advantageously, by combining the signals of at least one of the at least one HF motion sensors with the signals of the at least one pressure sensor and/or of the at least one flow sensor, a distinction can be made between different situations that lead to the same or similar reactions of at least one of the at least one HF motion sensors. The corresponding situations can be recognized and distinguished from each other using typical signal profiles of at least one of the at least one HF motion sensors in connection with data from the at least one pressure sensor and/or the at least one flow sensor in the fluid inlet, for example with the aid of a classifier or another suitable AI algorithm.

Furthermore, by networking the water system controller with at least one pressure and/or flow sensor or by directly integrating at least one pressure and/or flow sensor into the water consumer system, the flushing time can be adapted as a function of an actual water pressure and/or flow, and thus the flushing volume can be adjusted much more precisely to the given water consumer. If the water pressure or flow rate falls below a certain minimum for a certain time, the water consumer system according to an embodiment of the invention can send an error message and/or a service message.

The water system controller coupled to the inlet valve has a data processing system and/or is connected to a data processing system. The data captured by the at least one HF motion sensor is retrieved and/or received by the data processing system. The data is preferably transmitted via a wireless or mesh data transmission network, such as, for example, via Bluetooth or Bluetooth mesh. This advantageously enables communication with a mobile device, with a building control via a cloud or a building management system, and with other sensor products, either directly in the network or indirectly via at least one gateway. This is accompanied by the advantage of a simplified operating function as well as simple setting and/or diagnostic options and the simplification of retrieving operating data or displaying service requirements.

The data processing system registers deviations from predetermined reference values or from empirical values and/or a sensor's own operating data, for example with regard to the usual drainage times associated with a water consumer water process or the amount of fluid flowing out during a flushing process. In the event deviations occur, the data processing system can initiate at least one action to prevent the cause of the given deviation. In addition to a single HF motion sensor's own operating data, the data processing system can use data from other sensors or from a building control. For example, break times in a public facility, such as a theater or a sports facility, or the business hours of a building, can be taken into account.

One possible action to be triggered by the data processing system to avoid a malfunction in the water consumer system is, in particular, the adjustment of the opening time and/or the opening position and/or the opening frequency of the inlet valve, and/or the sending of an error message and/or a service message.

The inlet valve can, for example, be a solenoid valve with a defined opening time and/or opening position and/or opening frequency, which is activated by the water system controller.

As already explained above, if the fluid outlet is completely obstructed, fluid will build up in the water receptacle. Since the at least one HF motion sensor typically cannot penetrate the fluid, it no longer detects the flow of water as soon as the sensor region of the water receptacle is completely filled with fluid. If the at least one flow sensor in the fluid inlet simultaneously reports a water flow and thus a flushing process occurring, the data processing system detects a possible obstruction and does not trigger a new flush—that is, the inlet valve does not open again. In addition, an error message and/or service message can be sent immediately.

A sensory detection of a complete obstruction is also possible by differentiating between a water consumer that is filled with fluid completely, or up to a certain marking, and an empty water receptacle with a regular water level in the water seal. Such a distinction can be made by means of a signal analysis of the HF motion sensor. As already explained further above, due to the distance and/or material properties of the reflecting standing fluid in the vicinity of the sensor, there is a change in the phase position of the reflected signal of the HF motion sensor. This leads to a shift in the offset voltage of the HF motion sensor and thus to modified signal levels, which in turn can be recognized (or determined) by the data processing system.

Alternatively, the standing fluid can be detected using a different sensor method. In particular, another HF motion sensor method suitable for detecting static objects can be used—for example utilizing at least one frequency modulated continuous wave radar (FMCW), at least one capacitive sensor, and/or at least one other suitable sensor or sensor system.

If the water consumer system is only beginning to become obstructed, in the water consumer system according to an embodiment of the invention the HF motion sensor registers at least one extended draining time over a longer period of time. In the case of a partial obstruction, the same amount of flush water would require a longer draining time than if there was no obstruction. If the data processing system detects such a deviation from empirical and/or reference values, it triggers at least one action to prevent further deviations. Such an action can be the sending of an error message and/or a service message and/or the prevention of further flushing processes.

With an HF motion sensor attached to the fluid outlet, blockages in the outlet pipe can be detected early due to buildup of fluid in the pipe being detected by the HF motion sensor. Further, the HF motion sensor can detect whether the fluid flow is reducing over time indicating that the pipe is becoming restricted, e.g. due to a build-up of struvite in the case of a urinal. Therefore, complete or partial blockages in the fluid outlet can be detected before the fluid starts building up in the water consumer leading to fluid potentially leaking onto the floor. In the case of a urinal, upon detecting that a partial (or complete) blockage is occurring, a flush cleaning mode may be activated, as described in more detail herein in relation to other water consumer types. For example, based on the evaluated data, the flush cleaning mode attempts to clear or alleviate an obstruction in the fluid outlet connected to the urinal.

In one example in relation to a urinal, a flush unit in the form of a hollow ring with apertures may be arranged in the urinal (or the urinal pipe work) to provide multiple (e.g. 2, 3 or more) jets of water down the urinal (or down the pipe work). This flush unit may be activated to unblock, or at least partially clear the blockage in one or more flush cleaning cycles.

According to another example in relation to a urinal, a flush unit of the urinal may be activated multiple times over a defined time period. For example, the flush unit may be activated for a defined period of time (e.g. 15 minutes) multiple nights (e.g. every night) for a defined number of nights (e.g. 7 nights or 14 nights). This way, the blockage may be slowly cleared without requiring the need for expensive and time-consuming maintenance operations to clear the blockage.

In the event of a pressure fluctuation in a wastewater system connected to the water consumer system, for example due to improper installation, such as inadequate ventilation of the wastewater line, strong pressure fluctuations occur during a flushing process. This in turn can lead to a fluctuating water level in the water seal, or even to the water seal being removed by suction. If such a fluctuation is sensed as a motion by the at least one HF motion sensor, incorrect flushing may be triggered. The data processing system preferably recognizes a motion triggered by a fluctuating water level as such and does not trigger a new flushing process. One possible action is sending an error message and/or a service message and/or preventing a new flushing process. Such a faulty motion signal can be recognized by a signal analysis of the typical sensor signals based on empirical values and/or reference values with regard to the signal profile. These oscillations of this signal profile should settle down during a regular flushing process.

There can be different scenarios in the event of a malfunction in the fluid inlet. For example, it may be that the at least one HF motion sensor no longer registers any motion if the valve does not open and no fluid is flowing. The at least one HF motion sensor may also permanently register motion in the event that the valve does not close completely. It is also possible for the at least one HF motion sensor to register a reduced amount of fluid if the valve only opens incompletely and only a reduced amount of water is released during the flushing process. The action triggered by the data processing system is advantageously the sending of an error message and/or service message.

If the at least one HF motion sensor registers a permanent flow of fluid, the water supply of the water consumer system according to an embodiment of the invention can be interrupted by activating a shut-off valve, preferably via a wireless or mesh data transmission network, such as, for example, via Bluetooth or Bluetooth mesh

Advantageously, the water system controller activates the at least one HF motion sensor permanently, or at a certain predetermined time interval with pulses. If at least one of the at least one HF motion sensors fails, the absence of a reaction to the pulses is recognized (or determined) and an error message and/or a service message is sent.

The data processing system is preferably designed to recognize (or determine) a predefined water consumer usage situation and/or frequency of use on the basis of the evaluated data and, based on this, to adapt an opening time and/or an opening position and/or an opening frequency of the inlet valve in at least one subsequent water consumer water process.

In this way, for example, times of high traffic can advantageously be identified, and suitable and effective water-saving programs activated for the given situation. For example, a flushing interval and/or a flushing volume can be adapted to a predicted number of users of the water consumer system, and a cleaning flushing can be triggered at suitable times with an increased flushing volume compared to a regular flushing process.

The water consumer system according to an embodiment of the invention preferably has an error message and/or service message output unit coupled to the data processing system. In the event of an error or malfunction detected by the data processing system, the error message and/or service message output unit is instructed to issue an error message and/or a service message, which advantageously significantly shortens the period of time until the error or malfunction is recognized by a user and/or a service employee.

In an advantageous embodiment, the data processing system has at least one data processing block with machine learning (e.g. unsupervised machine learning), or comprising an artificial neural network, and/or containing an expert system.

By using the at least one data processing block with machine learning (e.g. unsupervised machine learning), or comprising an artificial neural network, and/or containing an expert system, the data processing system of the water consumer system according to an embodiment of the invention is advantageously able to make intelligent decisions based on its own operating data and additional data from other sensors or from a building control. In this way, for example, water consumption and/or convenience can be optimized for the user or users, and the amount of actions which must be carried out by people, for example to maintain the water consumer system, can be reduced.

The implementation of AI algorithms, that is to say algorithms using artificial intelligence, is preferably carried out directly in at least one of the at least one HF motion sensors as so-called “embedded AI.” At least one microcontroller connected to the HF motion sensor preferably has the resources required for this, such as a suitably large memory, a corresponding computing power, and/or availability of further suitable tools.

The object is further achieved by a water consumer system having a water consumer system according to an embodiment of the invention, wherein the water consumer system according to an embodiment of the invention has, in addition to the water consumer system, at least one further water consumer on which at least one further sensor is provided, wherein the data processing system is coupled to the at least one further sensor and is designed to likewise computationally evaluate the data captured by the at least one further sensor and received by the data processing system, and to include this data in the error or malfunction detection and/or error or malfunction prevention.

The water consumer system according to an embodiment of the invention can have a water consumer system or a plurality of water consumer systems, wherein the water consumer system or the water consumer systems can each have one water receptacle or a plurality of water receptacles.

The at least one further water consumer is preferably a sink, toilet bowl, cistern, shower or bath.

The at least one further sensor can be at least one infrared motion or proximity sensor, at least one capacitive motion or proximity sensor, at least one contactless push plate, at least one temperature sensor, and/or at least one HF motion or proximity sensor. For example, the at least one temperature sensor can also be used to detect the use of a water consumer by detecting a temperature change caused by a flow of fluid in a water consumer.

The at least one other sensor can also be used independently of the water consumer system, for example to recognize (or determine) an obstruction in the at least one further water consumer, such as a sink, toilet bowl, cistern, shower or bath. In this case it is possible, but not necessary, for the respective further water consumer to be controlled by means of the at least one further sensor.

Furthermore, it is possible to use the at least one additional sensor to inform the water system controller of the water consumer system of the water consumer system according to an embodiment of the invention that, for example, a toilet bowl in an adjacent room is being flushed, whereby a slight pressure fluctuation transmitted to the water system controller by means of a pressure sensor can be traced back to this flushing process.

For example, the at least one further sensor related to the further water consumer on which it is provided can also be simply an obstruction sensor that detects an obstruction of the given water consumer. Such an obstruction can, however, be reported by the at least one further sensor to the water system controller and/or to at least one further control of one of the other water consumers.

The at least one further sensor can be arranged at the outlet of the further water consumer, and/or at a different position.

The data that is captured by the at least one further sensor on the at least one further water consumer can, according to an embodiment of the invention, be transmitted to the data processing system and/or the water system controller. As a result, the data processing system and/or the water system controller learns that, for example, a toilet bowl is flushing and that pressure fluctuations in the drain and/or in the wastewater system can occur.

My means of the at least one further sensor, interactions in the water consumer system can also be sensed, and these can be incorporated by the water system controller. For example, as mentioned above, flushing a toilet bowl or use of another water consumer can lead to pressure fluctuations in the fluid outlet of the water consumer system. Accordingly, an incorrect flushing of the water consumer system can be prevented. This applies accordingly to other usage situations that can be recognized with the additional use of data from the further sensor.

If there is a pressure fluctuation in a wastewater system connected to the water consumer system, for example due to improper installation, such as insufficient ventilation of the wastewater pipe, strong pressure fluctuations occur during a flushing process, wherein these can lead to fluctuating water levels in the water seal or in the water seals of the water consumer system or water consumer systems and/or of the at least one further water consumer of the water consumer system, including emptying said water seal by suction. If such a fluctuation is recognized as a motion by at least one of the at least one HF motion sensors, incorrect flushing may be triggered.

The data processing system preferably recognizes a motion triggered by a fluctuating water level as such and does not trigger a new flushing process. One possible action is sending an error message and/or service message and/or preventing a new flushing process. This type of incorrect motion signal can be detected by a signal analysis of the typical sensor signals based on empirical values and/or reference values with regard to the signal profile. The oscillations of this signal profile should settle down during a regular flushing process. In addition, data from other motion sensors in the water consumer system can be evaluated, wherein the time at which other water consumers were used in relation to the signal from the HF motion sensor of the respective water consumer system can be noted.

The water consumers and the water consumer system are preferably connected to each other via a mesh network and/or a wireless local data transmission network.

This connection and a communication based on it between the water consumers and the water consumer system is particularly preferably carried out on the basis of a wireless or mesh data transmission network, such as Bluetooth or Bluetooth mesh. Advantageously, this form of connection enables the water consumer system to communicate with a mobile device, which has the advantage of a simplified operating function and simple adjustment and diagnosis options. It is also advantageous if the water consumer system can communicate with a building control via a cloud or a building management system, which in particular simplifies the retrieving of operating data or the display of service requirements. Another advantage of data transmission using a wireless or mesh data transmission network, such as Bluetooth or Bluetooth mesh, is the ability to communicate with other sensor products either directly in the network or indirectly via at least one gateway.

The object is further achieved by a method for operating a water consumer system having a water consumer having a water receptacle, a fluid inlet with an inlet valve, a fluid outlet, at least one HF motion sensor for detecting fluid motion provided on the water receptacle and/or the fluid outlet, and a water system controller which is coupled to the at least one HF motion sensor and the inlet valve and by means of which the inlet valve is opened for a predetermined time when the at least one HF motion sensor detects draining fluid, wherein, according to an embodiment of the invention, the water system controller has a data processing system and/or is connected to a data processing system that queries and/or receives at least data captured by the at least one HF motion sensor, evaluates it by computing, and recognizes on the basis of the evaluated data if at least one of the following malfunctions is present, and/or triggers at least one action to avoid at least one of the following malfunctions:
that the fluid outlet is obstructed, and/or
that there is a pressure fluctuation in a wastewater system connected to the water consumer system, and/or
that the fluid inlet and/or the inlet valve is/are malfunctioning, and/or
that at least one of the at least one HF motion sensors has failed,
   and/or recognizes a predefined water consumer usage situation and/or frequency of use on the basis of the evaluated data and, based on this, adapts an opening time and/or opening position and/or an opening frequency of the inlet valve thereto in at least one subsequent water consumer water process, wherein the water consumer is one of a sink, toilet bowl, cistern, shower, and bath.

Different water consumer water processes may be performed depending on the type of water consumer. For example, a water consumer process may be a process such as, opening a water inlet valve for a tap (to allow water to enter a water receptacle in the form of a sink bowl (i.e. part of a water consumer that is a sink) or a bath tub (i.e. part of a water consumer that is a bath)), opening a water inlet valve for a shower head (to allow water to enter a water receptacle in the form of a shower unit (i.e. part of a water consumer that is a shower)), opening a water inlet valve for a cistern (to allow water to enter a water receptacle in the form of a cistern unit (i.e. part of a water consumer that is a cistern)).

The water consumer system operated with the method according to an embodiment of the invention can have a water receptacle or a plurality of water receptacles.

The inlet valve of the water consumer system operated with the method according to an embodiment of the invention is preferably a solenoid valve with a defined opening time and/or opening position and/or opening frequency, which is activated by the water system controller of the water consumer system operated by the method according to an embodiment of the invention.

As already explained above, the at least one HF motion sensor is preferably arranged on the water receptacle and/or the fluid outlet in such a way that it is able to detect the motion of the flush water flowing from the fluid inlet to the fluid outlet during a water consumer water process, and/or fluid hitting the water receptacle during use of the water consumer system.

The at least one HF motion sensor is preferably fastened to the rear of the water receptacle directly or by means of a holding device, in particular glued to the rear of the water receptacle. The at least one HF motion sensor is preferably oriented in such a way that it does not point in the direction of a sealing water located in the odor trap of the fluid outlet. By arranging the at least one HF motion sensor in the immediate spatial vicinity of the fluid outlet, the at least one HF motion sensor can advantageously detect draining fluid.

The data acquired by the at least one HF motion sensor is retrieved and/or received by the data processing system, preferably via a wireless or mesh data transmission network, such as Bluetooth or Bluetooth mesh. This advantageously enables communication with a mobile device, with a building control via a cloud or a building management system and with other sensor products either directly in the network or indirectly via gateways. This is accompanied by the advantage of a simplified operating function, as well as simple setting and diagnosis options and the simplification of retrieving operating data or displaying service requirements.

The data processing system registers deviations from predetermined reference values or from empirical values or a sensor's own operating data, for example with regard to the usual drainage times associated with a water consumer water process or the amount of fluid flowing out during a flushing process. In the event deviations occur, the data processing system can initiate at least one action to prevent the cause of the given deviation. In addition to a single HF motion sensor's own operating data, the data processing system can use data from other sensors or from a building control. For example, break times in a public facility such as a theater or a sports facility, or the business hours of a building can be taken into account.

One possible action to be triggered by the data processing system to avoid a malfunction in the water consumer system is, in particular, the adjustment of the opening time and/or the opening position and/or the opening frequency of the inlet valve, and/or the sending of an error message and/or a service message.

Attention is hereby directed to the entirety of the foregoing explanations with regard to the detection of deviations in the sensor signals in the event of a complete or partial obstruction, a pressure fluctuation in a wastewater system connected to the water consumer, a malfunction in the fluid inlet, a failure of at least one of the at least one HF motion sensors, and also the actions to be triggered by the data processing system in each case.

The detection of a predefined water consumer usage situation and/or frequency of use and reaction to this also takes place as described above.

An embodiment of the method according to an embodiment of the invention is preferred in which, in the fluid inlet, a fluid pressure is detected with at least one pressure sensor and/or a fluid flow is detected with at least one flow sensor, the detected fluid pressure and/or the detected fluid flow is/are transmitted to the data processing system, and the data processing system computationally evaluates the detected fluid pressure and/or the detected fluid flow with the data retrieved and/or received from the at least one HF motion sensor, and recognizes on the basis of the evaluated data if at least one of the following malfunctions is present, and/or triggers at least one action to avoid at least one of the following malfunctions:
that the fluid outlet is obstructed, and/or
that there is a pressure fluctuation in a wastewater system connected to the water consumer system, and/or
that the pressure in the fluid inlet has dropped below a minimum pressure value, or has exceeded a maximum pressure value, and/or
that the fluid inlet and/or the inlet valve is/are malfunctioning, and/or
that at least one of the at least one HF motion sensors has failed,
   and/or recognizes a predefined water consumer usage situation and/or frequency of use on the basis of the evaluated data and, based on the same, adapts an opening time and/or an opening position and/or an opening frequency of the inlet valve in at least one subsequent water consumer water process, wherein the water consumer is one of a sink, toilet bowl, cistern, shower, and bath.

Different water consumer water processes may be performed depending on the type of water consumer. For example, a water consumer process may be a process such as, opening a water inlet valve for a tap (to allow water to enter a water receptacle in the form of a sink bowl (i.e. part of a water consumer that is a sink) or a bath tub (i.e. part of a water consumer that is a bath)), opening a water inlet valve for a shower head (to allow water to enter a water receptacle in the form of a shower unit (i.e. part of a water consumer that is a shower)), opening a water inlet valve for a cistern (to allow water to enter a water receptacle in the form of a cistern unit (i.e. part of a water consumer that is a cistern)).

Advantageously, by the computational evaluation of the data from the at least one pressure sensor and/or the at least one flow sensor with respect to the data from at least one of the at least one HF motion sensors, different malfunctions can be distinguished that lead to identical or similar reactions from at least one of the at least one HF motion sensors.

The absence of a reaction of at least one of the at least one HF motion sensors to a previously triggered flushing can be attributed, for example, to the fact that a complete obstruction is present, and due to this, at least one of the at least one HF motion sensors is blind, to the fact that the inlet valve is not opening due to a valve malfunction or an electronics defect, or to the fact that there is a malfunction in the water supply. If at least one pressure sensor reports an existing optimal fluid pressure at the same time, a malfunction in the water supply can be ruled out. If the at least one flow sensor reports at the same time that there is an inflow of fluid, the data processing system will assume an obstruction of the fluid outlet as the most likely scenario, and can trigger corresponding actions, as already described above.

The evaluation of the sensor data by the data processing system is preferably carried out using a classifier or another suitable AI algorithm by comparing typical signal profiles of at least one of the at least one HF motion sensors in connection with data from the at least one pressure sensor and/or the at least one flow sensor in the fluid inlet.

The data processing system advantageously directly recognizes when pressure in the fluid inlet drops below a minimum pressure value, or exceeds a maximum pressure value, by evaluating the data from the at least one pressure sensor. The data processing system can then trigger appropriate actions, such as preventing a further flushing process and/or sending an error message and/or service message.

Attention is hereby directed to the entirety of the foregoing explanations with regard to the detection of deviations in the sensor signals from at least one of the at least one HF motion sensors in the event of a complete or partial obstruction, a pressure fluctuation in a wastewater system connected to the water consumer, a malfunction in the fluid inlet, a failure of at least one of the at least one HF motion sensors, and also the actions to be triggered by the data processing system in each case.

The detection of a predefined water consumer usage situation and/or water consumer usage frequency and reaction to this can also take place as described above.

The object is also achieved by a method for operating a water consumer system having a water consumer having a water receptacle, a fluid inlet with an inlet valve, a fluid outlet, at least one HF motion sensor for detecting fluid motion provided on the water receptacle and/or the fluid outlet, and a water system controller which is coupled to the at least one HF motion sensor and the inlet valve and by means of which the inlet valve is opened for a predetermined time when the at least one HF motion sensor detects draining fluid, wherein, according to an embodiment of the invention, in the fluid inlet a fluid pressure is detected with at least one pressure sensor and/or a fluid flow is detected with at least one flow sensor, and the water system controller has a data processing system and/or is connected to a data processing system that queries and/or receives data captured by the at least one HF motion sensor and/or the at least one pressure sensor and/or the at least one flow sensor, evaluates it by computing, and recognizes on the basis of the evaluated data if at least one of the following malfunctions is present, and/or triggers at least one action to avoid at least one of the following malfunctions:
that the fluid outlet is obstructed, and/or
that there is a pressure fluctuation in a wastewater system connected to the water consumer and/or
that the pressure in the fluid inlet has dropped below a minimum pressure value, or has exceeded a maximum pressure value, and/or
that the fluid inlet and/or the inlet valve is/are malfunctioning, and/or
that there is a failure of at least one of the at least one HF motion sensors;
   wherein the water consumer is one of a sink, toilet bowl, cistern, shower, and bath.

Different water consumer water processes may be performed depending on the type of water consumer. For example, a water consumer process may be a process such as, opening a water inlet valve for a tap (to allow water to enter a water receptacle in the form of a sink bowl (i.e. part of a water consumer that is a sink) or a bath tub (i.e. part of a water consumer that is a bath)), opening a water inlet valve for a shower head (to allow water to enter a water receptacle in the form of a shower unit (i.e. part of a water consumer that is a shower)), opening a water inlet valve for a cistern (to allow water to enter a water receptacle in the form of a cistern unit (i.e. part of a water consumer that is a cistern)

Advantageously, by the computational evaluation of the data from the at least one pressure sensor and/or the at least one flow sensor with respect to the data from at least one of the at least one HF motion sensors, different malfunctions can be distinguished that lead to identical or similar reactions from at least one of the at least one HF motion sensors. In this regard, reference is made to the entirety of the foregoing explanations.

The data processing system preferably detects that the fluid outlet is obstructed and/or the fluid inlet is malfunctioning if, despite the open inlet valve, the at least one HF motion sensor detects no running fluid and/or the at least one HF motion sensor detects that at least a lower region within the water receptacle is filled with standing fluid.

Advantageously, the data processing system can trigger an immediate action to prevent the water receptacle from overflowing. Such an action can be the prevention of a further flushing process and/or the sending of an error message and/or service message.

In particular, the data processing system detects whether the fluid outlet is obstructed or the fluid inlet is malfunctioning if, despite the open inlet valve and the fluid pressure detected by the at least one pressure sensor and/or the fluid flow detected by the at least one flow sensor, the at least one HF motion sensor detects no running fluid, and/or the fact that at least a lower region within the water receptacle is filled with standing fluid is detected by means of the at least one HF motion sensor.

With regard to the detection of deviations in the sensor signals from at least one of the at least one HF motion sensors in the event of a complete obstruction, reference is made to the entirety of the foregoing explanations.

The combination of the data from the at least one pressure sensor with the data from the at least one flow sensor and the data from the at least one HF motion sensor advantageously allows a possible malfunction to be localized more precisely. As already described above, the absence of a reaction of at least one of the at least one HF motion sensors to a previously triggered flush can be attributed, for example, to the fact that there is a complete obstruction, and due to this at least one of the at least one HF motion sensors is blind, to the fact that the inlet valve is not opening due to a valve malfunction or an electronic malfunction, or to the fact that there is a malfunction in the water supply. If at least one pressure sensor reports an existing optimal fluid pressure at the same time, a malfunction in the water supply can be ruled out. If the at least one flow sensor reports at this time that there is an inflow of fluid, the data processing system will assume an obstruction of the fluid outlet as the most likely scenario and can trigger appropriate actions, as already described above.

The data processing system preferably detects that the fluid outlet is partially obstructed and/or the fluid inlet is malfunctioning if, despite the open inlet valve, the at least one HF motion sensor detects that fluid is draining from the water receptacle with a time delay.

With regard to the detection of deviations in the sensor signals from at least one of the at least one HF motion sensors in the event of a partial obstruction, as well as the combination of the data from at least one of the at least one HF motion sensors with the data from the at least one flow sensor, reference is hereby made to the entirety of the foregoing explanations.

In a further preferred embodiment, the data processing system recognizes whether the fluid outlet is partially obstructed or the fluid inlet is malfunctioning if, despite the inlet valve being open and fluid pressure detected by the at least one pressure sensor and/or the fluid flow detected by the at least one flow sensor, the at least one HF motion sensor detects that fluid is draining from the water receptacle with a time delay.

With regard to the detection of deviations in the sensor signals from at least one of the at least one HF motion sensors in the event of a partial obstruction, as well as the combination of the data from at least one of the at least one HF motion sensors with the data from the at least one flow sensor and/or the data from the at least one pressure sensor, reference is hereby made to the entirety of the foregoing explanations.

In the method according to an embodiment of the invention, the specific opening time of the inlet valve is preferably adapted by the water system controller in the entire pressure and/or flow range to the specific fluid pressure and/or the specific fluid flow in the fluid inlet—that is, the respective flushing volume is regulated.

In advantageous embodiments of the method according to an embodiment of the invention, when it is recognized that the pressure in the fluid inlet has fallen below a minimum value or has exceeded a maximum pressure value, in addition to the adaptation of the opening time of the inlet valve to the fluid pressure and/or the fluid flow in the fluid inlet, the data processing system and/or the water system controller issues an error message or service message. According to an embodiment of the present invention, the permitted pressure range is, for example, 2 to 8 bar.

In the case of an embodiment of the present invention, the specific opening time of the inlet valve during flushing is preferably continuously adapted to determined pressure and/or flow values. In the event of lower pressure and/or flow values, the inlet valve is opened for a longer period of time in order to ensure a sufficient flow of water and thus sufficient cleaning of the water receptacle. For higher pressure and/or flow values, the inlet valve is opened for a shorter time in order to avoid unnecessarily high water consumption.

If the pressure falls below a minimum value, such as below 2 bar, for example, and/or exceeds a maximum pressure value such as 8 bar, for example, a service or error message is preferably output by the data processing system and/or the water system controller.

The data processing system preferably detects that the fluid inlet is malfunctioning when the at least one HF motion sensor detects no fluid flow and/or a permanent fluid flow and/or a fluid flow below a fluid flow threshold value.

In the event of a malfunction in the fluid inlet, the result may be that the HF motion sensor no longer registers any motion because the valve does not open and no fluid flows, that the HF motion sensor permanently registers motion because the valve does not close completely, or that the HF motion sensor registers a reduced amount of fluid because the valve only opens incompletely and only a reduced amount of water is released during the flushing process.

If the HF motion sensor registers a permanent flow of fluid, the water supply of the water consumer system according to an embodiment of the invention can be interrupted by controlling a shut-off valve, preferably via a wireless or mesh data transmission network such as Bluetooth or Bluetooth mesh, in order to avoid unnecessarily high water consumption or fluid overflow.

If the at least one HF motion sensor does not detect a flow of fluid over a longer period of time, the data processing system can be used to check whether the at least one HF motion sensor has failed. Advantageously, the water system controller activates the at least one HF motion sensor permanently, or at a certain predetermined time interval with pulses. If the at least one HF motion sensor fails, the absence of a reaction to the pulses is recognized and an error message and/or a service message is sent.

In a preferred embodiment of the method according to an embodiment of the invention, the water consumer system has an error message and/or service message output unit coupled to the data processing system, and the data processing system outputs a service message to the error message and/or service message output unit when it detects at least one of the malfunctions.

This advantageously significantly shortens the period of time until the malfunction is recognized by a user and/or a service employee. An error message and/or service message can, for example, be sent directly to a smartphone or another mobile device or a building control.

The data processing system preferably recognizes that there is a pressure fluctuation in the wastewater system connected to the water receptacle if a series of successive incorrect water consumer water processes in the water consumer system is found in the profile of the data from the at least one HF motion sensor, and/or if a signal pattern of the data from the at least one HF motion sensor corresponds to a characteristic fluctuation of the fluid level in the fluid outlet.

As already explained above, in the event of a pressure fluctuation in a wastewater system connected to the water consumer system, for example due to improper installation, such as insufficient ventilation of the wastewater line, strong pressure fluctuations during a flushing process can lead to fluctuations in the water level in the water seal up to and including emptying of the water seal by suction. If such a fluctuation is sensed as a motion by the HF motion sensor, incorrect flushing can be triggered. The data processing system preferably recognizes a motion triggered by a fluctuating water level as such.

In particular, when the data processing system detects that there is a pressure fluctuation in a wastewater system connected to the water consumer system, the water system controller changes a sensitivity of the at least one HF motion sensor, and/or does not trigger a water consumer water process if a signal pattern of the data from the at least one HF motion sensor corresponds to a characteristic fluctuation of the fluid level in the fluid outlet.

By changing the sensitivity of the at least one HF motion sensor, in one embodiment of the method according to an embodiment of the invention, a fluctuating water level triggered by pressure fluctuations is not recognized as regular use. This advantageously avoids incorrect flushing and the associated unnecessary increase in water consumption.

The prevention of further water consumer water processes when a characteristic fluctuation of the fluid level in the fluid outlet is detected also ensures that unnecessarily increased water consumption is avoided.

The data processing system preferably has at least one data processing block that learns by machine learning (e.g. unsupervised machine learning, and/or works on the basis of an artificial neural network and/or is an expert system.

The data processing system is thereby advantageously able to make intelligent decisions based on its own operating data and additional data from other sensors or from a building control system. In this way, for example, water consumption and/or convenience can be optimized for the user, and/or the amount of human intervention can be reduced.

In a preferred embodiment of the method according to an embodiment of the invention, the water consumer system has at least one further water consumer on which at least one further sensor is provided, wherein the data processing system is coupled to the at least one further sensor and likewise evaluates the data received from the at least one further sensor computationally, wherein at least one flushing time and/or obstruction in an outlet, and/or a pressure fluctuation in a wastewater system and/or a malfunction of an inlet device of the at least one further water consumer determined in this case is/are incorporated into the detection of at least one of the malfunctions.

The at least one further water consumer is, for example, a sink, toilet bowl, cistern, shower or bath.

The at least one further sensor can be at least one infrared motion or proximity sensor, at least one capacitive motion sensor, at least one contactless push plate, at least one temperature sensor and/or at least one HF motion or proximity sensor.

The at least one other sensor can also be used independently of the water consumer system, for example to recognize (or determine) an obstruction on the at least one other water consumer, such as a sink, or other further water consumer. In this case it is possible, but not necessary, for the respective further water consumer to be controlled by means of the at least one further sensor.

For example, the at least one further sensor related to the further water consumer on which it is provided can be simply be an obstruction sensor that detects an obstruction of the given water consumer. Such an obstruction can, however, be reported by the at least one further sensor to the water system controller and/or to at least one further control of one of the other water consumers.

My means of the at least one further sensor, interactions in the water consumer system can also be recognized, and these can be incorporated by the water system controller. For example, flushing a toilet bowl can lead to pressure fluctuations in the fluid outlet of the water consumer system. Accordingly, an incorrect flushing of the water consumer system can be prevented. This applies accordingly to other usage situations that can be recognized with the additional use of data from the further sensor.

The at least one further sensor can be arranged at the outlet of the further water consumer, and/or at a different position.

The data that is captured by the at least one further sensor on the at least one further water consumer can, according to an embodiment of the invention, be transmitted to the data processing system and/or the water system controller. As a result, the data processing system and/or the water system controller learns that, for example, a toilet bowl is flushing and that pressure fluctuations in the drain and/or in the wastewater system can occur.

The combination of the data from several sensors advantageously enables functions that are not possible with a conventional sensor or are only possible through human decisions and human intervention. For example, typical usage situations can be recognized, times of high traffic can be identified, and suitable and effective water-saving programs can be activated for the given situation.

The determined flushing time of the at least one further water consumer can be used to identify a failure in the inlet of the water consumer system. For example, an only-partially open inlet valve can result in deviations in the flushing times of the at least one additional water consumer.

An obstruction in the outlet of the at least one further water consumer or a malfunction of an inlet device of the at least one further water consumer can lead to more users resorting to the functioning water consumer system, which leads to an increased frequency of use. In this case, suitable water-saving programs could be activated.

The water consumers and the water consumer system preferably communicate with each other via a mesh network and/or a wireless local data transmission network.

This advantageously enables communication with a mobile device, which has the advantage of a simplified operating function as well as simple setting and diagnosis options. It is also advantageous that communication with a building control is made possible via a cloud or a building management system, which in particular simplifies the retrieving of operating data or the display of service requirements. Another advantage of data transmission using a wireless or mesh data transmission network, such as Bluetooth or Bluetooth mesh, is the ability to communicate with other sensor products either directly in the network or indirectly via gateways.

Furthermore, a failure of at least one of the at least one HF motion sensors preferably exists when the data processing system does not receive any data from at least one of the at least one HF motion sensors, or the data received by the data processing system from the at least one of the at least one HF motion sensors cannot be processed by the data processing system, and/or at least one of the at least one HF motion sensor outputs at least one service signal.

The water system controller preferably activates the at least one HF motion sensor permanently or at a certain predetermined time interval with pulses. If at least one of the at least one HF motion sensors fails, the absence of a reaction to the pulses is recognized and an error message and/or a service message is sent.

A failure of at least one of the at least one HF motion sensors can thereby advantageously be distinguished from a longer period of non-use of the water consumer.

### BRIEF DESCRIPTION OF THE DRAWINGS

The invention is explained in more detail below with reference to exemplary embodiments and the associated figures, without being restricted to these.

In the figures:

FIG. 1 is a schematic view of an embodiment of a water consumer system according to an embodiment of the invention during a toilet bowl flushing process;

FIG. 2 is a schematic view of an embodiment of a water consumer system according to an embodiment of the invention with a completely obstructed toilet bowl outlet;

FIG. 3 is a flow diagram of a water pressure-adapted water process control of a water consumer system according to an embodiment of the invention;

FIG. 4 is a flow chart for recognizing a reaction to an obstruction of an embodiment of a water consumer system according an embodiment of to the invention;

FIG. 5 is a flow chart for valve diagnosis in an embodiment of a water consumer system according to an embodiment of the invention;

FIG. 6 is a flow chart for saving water in an embodiment of a water consumer system according to an embodiment of the invention;

FIG. 7 is a schematic view of an embodiment of a water consumer system according to an embodiment of the invention monitoring obstruction of pipework;

FIGS. 8A and 8B show example embodiments of a toilet system according to an embodiment of the invention;

### DETAILED DESCRIPTION

The following provides a description of an example of a water consumer system where the water consumer is a toilet bowl. It will be understood that, as an alternative, the water consumer may be a sink, cistern, shower or bath.

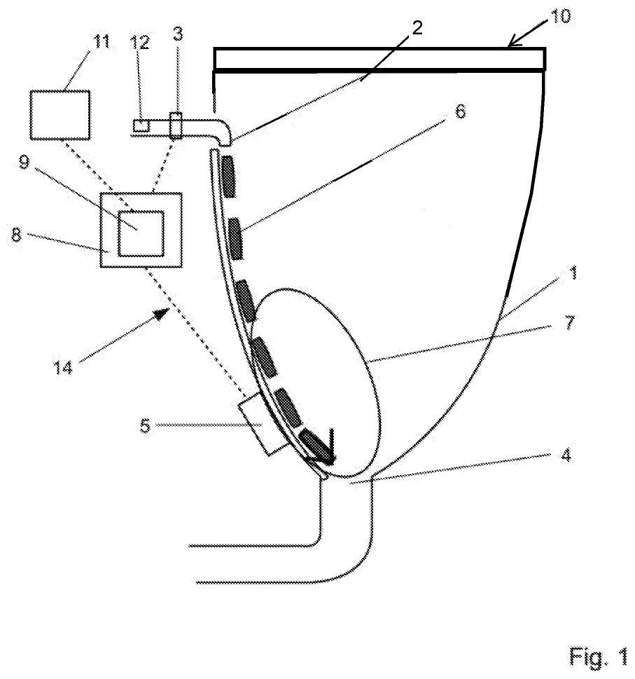

FIG. 1 is a schematic view of an embodiment of a water consumer system 10 according to an embodiment of the invention during a flushing process of a water consumer in the form of a toilet bowl.

The water consumer system 10 has a water receptacle 1 in the form of a toilet bowl with a fluid inlet 2 and a fluid outlet 4.

An inlet valve 3 is provided on the fluid inlet 2, with which the fluid inlet 2 can be opened or closed. When the inlet valve 3 is open, flush water 6 flows from the fluid inlet 2 via the toilet bowl 1 to the fluid outlet 4.

In the exemplary embodiment shown, an HF motion sensor 5 is attached to the back of the toilet bowl 1. In other embodiments of the present invention, several HF motion sensors 5 can also be provided on the toilet bowl 1 and/or at the fluid outlet 4.

The HF motion sensor 5 is oriented in such a way that its capture field 7 is inside the toilet bowl 1. The HF motion sensor 5 is thus able to register a motion of flowing flush water 6 as soon as it passes the capture field 7 of the HF motion sensor 5.

The data captured by the HF motion sensor 5 is transmitted to a data processing system 9 of a water consumer controller 8 of the water consumer system 10 and evaluated computationally by the same. In the exemplary embodiment shown in FIG. 1, the data processing system 9 is a microcontroller integrated into the water consumer controller 8; but in other embodiments of the invention, it can also be provided separately from the water consumer controller 8 and be, for example, a cloud or a gateway. In the exemplary embodiment shown, the data processing system 9 is coupled to an error message and/or service message output unit 11.

If at least one malfunction in the water consumer system 10 is recognized on the basis of this transmitted data, the data processing system 9 can trigger at least one corresponding action in order to prevent the at least one malfunction. Such an action can, for example, be preventing the inlet valve 3 from reopening, and/or sending an error message and/or service message to the error message and/or service message output unit 11.

In the embodiment of the invention shown in FIG. 1, a pressure sensor 12 is arranged in the fluid inlet 2. In other embodiments of the present invention, a flow sensor can also be arranged instead of the pressure sensor 12 or in addition to the pressure sensor 12. In addition, a plurality of pressure sensors 12 and/or flow sensors can also be arranged in the course of the fluid inlet 2. Furthermore, there are simple embodiments of the present invention in which the water consumer system has neither a pressure sensor nor a flow sensor in the fluid inlet 2.

In the water consumer system 10, fluid flows into the water consumer outlet 4 via the inside of the toilet bowl 1, which is typically made of ceramic. Incoming urine may be recognized by the HF motion sensor 5. The HF motion sensor 5 may then send a corresponding signal to the water consumer controller 8, which opens the inlet valve 3 in the fluid supply line 2 for a certain time when a certain amount of fluid motion is detected, and thus triggers the toilet bowl to be flushed. Alternatively, the toilet bowl may be flushed automatically by a flush activation system (not shown).

For example, the inlet valve 3, which is, for example, a solenoid valve, is opened for about 2 to 8 seconds depending on the set flushing volume. After the inlet valve 3 is closed, the water continues to flow for a certain time, due to various effects:
hydraulic delay of the inlet valve 3, which is typically on the order of 1 to 2 seconds, and/or
slow replacement of fluid from hoses or pipes between the inlet valve 3 and the fluid inlet and/or a water reservoir, which can take place over a longer period of up to 30 seconds, and/or
slow drainage of fluid from the ceramic surface of the toilet bowl 1, which can occur over a period of 5 to 10 seconds, and/or
slow drainage of fluid due to a partially obstructed fluid outlet 4, which leads to a longer observation of the drainage of the fluid by the at least one HF motion sensor 5.

Because, in embodiments of the present invention, motion data (of the water flush) captured continuously or in stages by the at least one HF motion sensor 5 is transmitted to the water consumer controller 8, according to an embodiment of the invention a typical behavior is learned by the data processing system 9 connected to or integrated into the water consumer controller 8, wherein deviations from normal operation, such as a beginning obstruction due to slowly increasing drainage time of fluid at the water consumer system 10, are recognized via a trend analysis carried out by the data processing system 9. In embodiments of the present invention, environmental conditions such as cleaning processes in the water consumer system 10 and/or a water pressure detected in the fluid supply line 2, may also be taken into account.

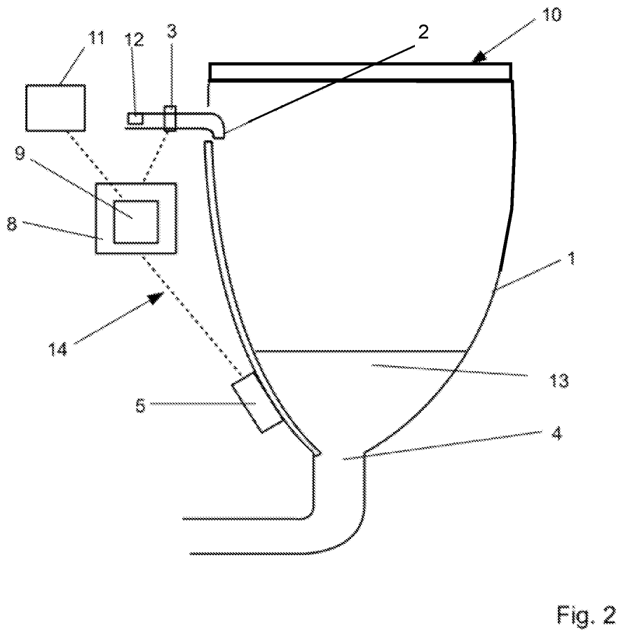

FIG. 2 shows a schematic view of a water consumer system 10 designed as in FIG. 1, with a completely obstructed fluid outlet 4. In the toilet bowl 1, there is a fluid 13 above the obstructed fluid outlet 4. The detection area 7 of the HF motion sensor 5 shown in FIG. 1 is completely covered with the fluid 13 in the state shown in FIG. 2.

Since the HF motion sensor 5 cannot penetrate the fluid 13, it does not register any motion of the arriving fluid, and accordingly does not register any use of the toilet bowl. The data processing system 9 thus does not trigger any opening of the inlet valve 3 of the fluid inlet 2. In addition to preventing the inlet valve 3 from reopening, an obstruction can be reported to a mobile device or a building control.

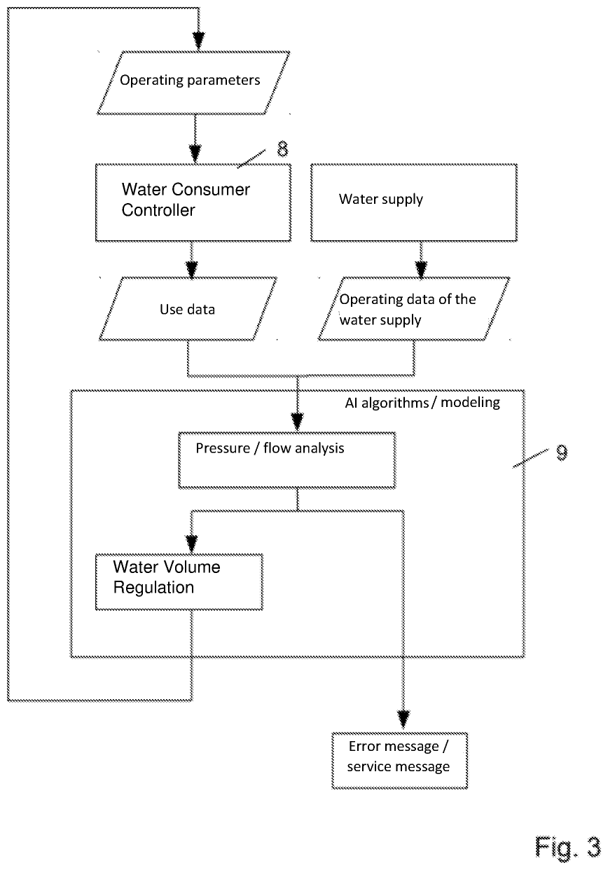

FIG. 3 shows a flow diagram of a flush control adapted to the water pressure of an embodiment of a water consumer system 10 according to an embodiment of the invention, which can be designed similarly to the embodiment in FIGS. 1 and 2, which is why reference is made below to the reference numerals used in FIGS. 1 and 2.

The water consumer controller 8 is coupled to at least one HF motion sensor 5 for detecting the use of the water consumer system 10 and at least one actuator for triggering a flush. The at least one actuator is an inlet valve 3, which is designed as a solenoid valve in the exemplary embodiment shown. The water consumer controller 8 captures usage data, among other things, via the at least one HF motion sensor 5. Based on this data, the water consumer controller 8 determines, for example, the water consumption of the water consumer system 10, usage statistics and/or a time profile of a usage process. For example, 8 flushes are counted by the water consumer controller for this purpose, multiplied by the given flushing volume and, if necessary, pressure and/or flow values are added.

For the water supply of the water consumer system 10, parameters such as the water pressure and/or the flow rate are detected as operating data of the water supply. For this purpose, the at least one pressure sensor 12 and/or the at least one flow sensor are arranged in the fluid inlet 2.

The usage data captured by the water consumer controller 8 and the operating data of the water supply are transmitted to the data processing system 9 and used for computational evaluation. The computational evaluation is carried out using AI algorithms and/or modeling.

An analysis of the pressure and flow rate takes place in the data processing system 9. There is a recognition of overpressure or underpressure, a recognition of pressure fluctuations, pressure peaks and other problems of the water supply, and a recognition of trends. Furthermore, the data processing system 9 establishes a relationship with the usage data of the water consumer system 10.

In the event of critical pressure conditions, such as overpressure or underpressure, an error message and/or service message is sent to the building operator, a plumber, a building management system, a cloud and/or the responsible water supplier. A warning or an alarm can also be triggered.

In the case of regular pressure conditions, a water volume regulation takes place in the water consumer system 10 via the water consumer controller 8. In this case, a water process time (e.g. flush time) in the water consumer system 10 is adapted to a detected water pressure or a detected flow rate, with fluctuations and trends being taken into account. The aim is a proper water processing (e.g. flushing) of the water consumer system 10, as completely as possible. When the water processing time is adjusted, the operating parameters of the water consumer system 10 are adjusted, and in turn are transmitted to the water consumer controller 8.

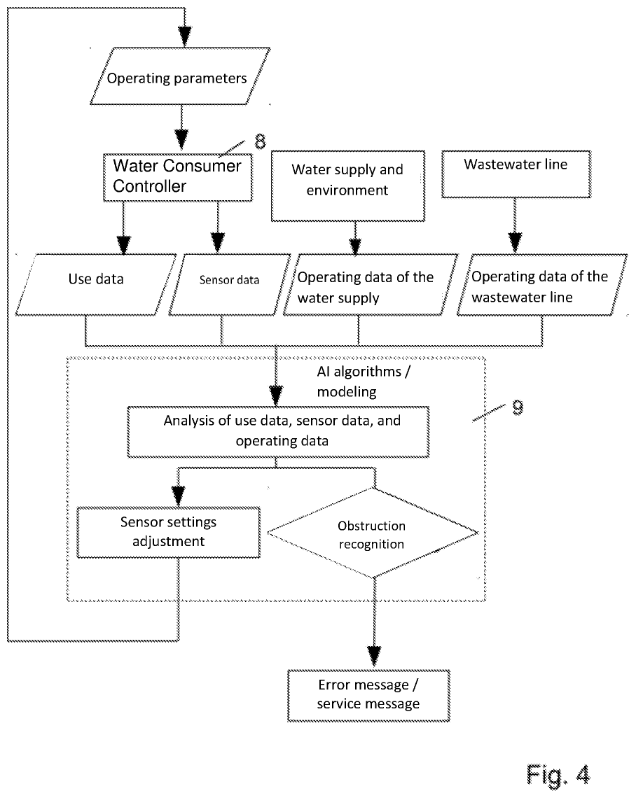

FIG. 4 shows a flow chart for recognizing and reacting to an obstruction in an embodiment of a water consumer system 10 according to an embodiment of the invention. The same reference numerals are used here as above; reference is made to the description above.

The water consumer controller 8 is coupled to at least one HF motion sensor 5 for detecting various parameters and to at least one actuator for triggering a flush. The parameters recognized by the at least one HF motion sensor 5 are water consumer use, flowing flush water 6, drainage behavior and speed, as well as fluid 13 being in the toilet bowl 1 in the form of retained water.

The at least one actuator in this case is an inlet valve 3 which, in the embodiment shown, is designed as a solenoid valve.

The water consumer controller 8 captures usage data and sensor data. The usage data contains, for example, the water consumption of the water consumer system 10, usage statistics, or the profile of a usage process over time. The sensor data contains a flush water flow, the drain rate, and/or the presence of an obstruction and/or fluid 13 located in the toilet bowl 1, such as retained water, for example.

For the water supply of the water consumer system 10, parameters such as water pressure, flow rate, water quality and/or water temperature are captured as operating data of the water supply. For this purpose, at least one pressure sensor 12 and/or at least one flow sensor and/or at least one temperature sensor are arranged in the fluid inlet 2. For example, water quality data relate to the lime content of the water.

For a wastewater line connected to the fluid outlet 4, the flow rate and/or a possible obstruction are captured as operating data of the wastewater line.

The usage data and sensor data from the water consumer controller 8, the operating data of the water supply and the operating data of the wastewater line is then analyzed with the help of AI algorithms. An analysis of the drainage behavior, a trend analysis to detect changes, the detection of existing and beginning obstructions, the detection of a declining drainage performance, and/or the detection of service requirements are carried out.

If the water consumer system 10 is completely obstructed, fluid builds up in the toilet bowl 1, as can be seen schematically in FIG. 2. If the capture area 7 of the HF motion sensor 5 in the toilet bowl 1 shown in FIG. 1 is filled with fluid, the HF motion sensor 5 no longer detects a flow of fluid because the HF signal from the HF motion sensor 5 typically cannot penetrate the standing fluid 13. In this situation, no use is detected and, if the device is completely obstructed, no flushing is detected.

With embodiments of the present invention, this situation can be recognized without delay. Due to the gradually-increasing re-fill time of fluid in the water consumer system 10, the trend analysis carried out by the data processing system 9 results in the decision that obstruction is beginning. When evaluating the re-fill time, environmental conditions such as water pressure, cleaning, optionally flushing of further fittings, etc. can be taken into account.

If an obstruction, a beginning obstruction or a decreasing drainage capacity is detected in the water consumer system 10, the water consumer controller 8 and/or the data processing system 9 sends an error message and/or service message to the building operator, a plumber, a building management system and/or a cloud. The drain should then be checked and, if necessary, a water seal in the water consumer system 10 should be changed.

If neither an obstruction nor a beginning obstruction or a declining drainage capacity is detected, settings on the water consumer system 10 may be adjusted, such as adjusting the flushing time or adjusting the flushing interval. With the adjustment of the flushing time and/or the flushing interval, the operating parameters are adjusted, which in turn are transmitted to the water consumer controller.

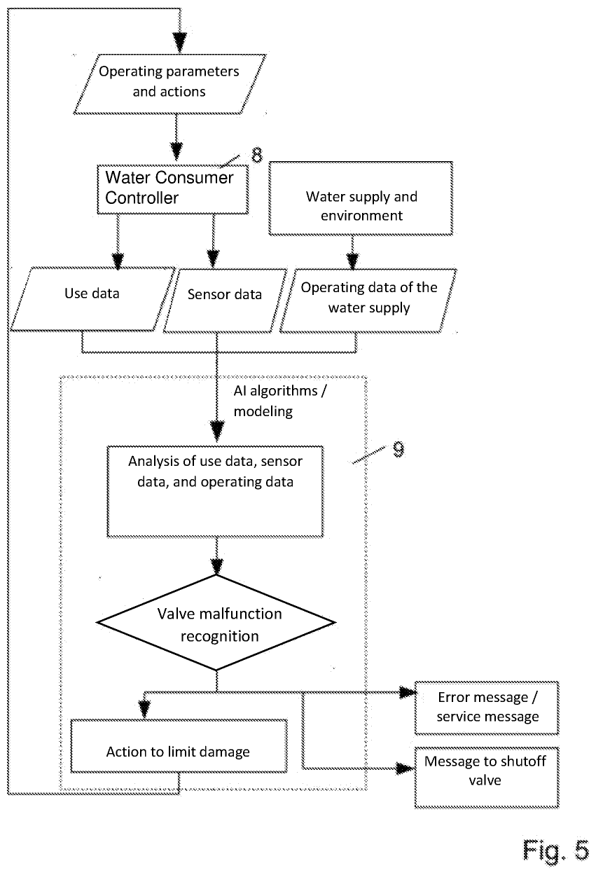

FIG. 5 is a flow diagram for valve diagnosis on an inlet valve 3 of an embodiment of a water consumer system 10 according to an embodiment of the invention, which is designed in accordance with or similar to the embodiment of FIGS. 1 and 2, to which reference is made below.

In the method shown in FIG. 5 and carried out with the water consumer system 10, operating parameters are detected and/or stored continuously or at predetermined time intervals by the water consumer controller 8 of the water consumer system 10. Such operating parameters can, for example, also be operating parameters initiated by the water consumer controller 8 itself, such as a flushing time at one or more toilet bowls of the water consumer system 10 and/or actions carried out on the water consumer system 10, such as the opening and/or closing of at least one inlet valve 3 of the water consumer system 10.

The water consumer controller 8 is coupled to at least one HF motion sensor 5 arranged on the toilet bowl 1 and/or the fluid outlet 4. The water consumer controller 8 can also form a structural unit with the at least one HF motion sensor 5.

The at least one HF motion sensor 5, together with the water consumer controller 8, for example, detects a water consumer use and/or flowing flush water 6 and/or a drainage behavior at a water consumer and/or a drainage speed at the water consumer and/or fluid 13, such as retained water, in the toilet bowl 1.

Furthermore, as already mentioned above, the water consumer controller 8, which is also coupled to at least one inlet valve 3 provided in the fluid inlet 2, and can control it, detects and/or saves actions performed at the inlet valve 3, such as triggering a flush and the duration thereof.

The data captured and/or stored by the water consumer controller 8 can be subdivided into usage data and sensor data.

The usage data can contain data on the water consumption of the water consumer system 10 and/or on the usage statistics of the water consumer system 10 and/or on the chronological profile of uses of the water consumer system 10.

The sensor data can include data on the flush water flow in the water consumer system 10 and/or on the flow rate in the water consumer system 10 and/or on an obstruction in the water consumer system 10 and/or on the presence of retained water in the toilet bowl 1 and/or on a flow profile at the inlet valve 3.

In addition, operating data from a water supply connected to the water consumer system 10 and/or from the surroundings of the water consumer system 10 is captured for the water consumer system 10. Such operating data can, for example, be a water pressure detected with the pressure sensor 12 provided in the fluid supply line 2 and/or a water flow rate detected in the fluid supply line and/or data on the water quality, such as lime content, the water supplied to the water consumer system 10 and/or the water temperature of the water supplied to the water consumer system 10.

The usage data, the sensor data and the operating data are processed by the data processing system 9. The data processing system 9 works using artificial intelligence (AI) methods and on the basis of modeling.

Each of the following processes can be carried out individually or in combination in the data processing system 9 on the basis of an analysis of the sensor data, the usage data and the operating data of the water supply:

Analysis of pressure and/or flow rate during a water consumer water process in the water consumer system 10
Analysis of a water flow during a water consumer water process in the water consumer system 10
Analysis of a drainage behavior in the water consumer system 10
Trend analysis
Detection of changes to the water consumer system 10
Detection of at least one valve malfunction at the inlet valve 3 in the event of a failure to open or a failure to close
Detection of insufficient flow in the water consumer system 10
Analysis of a power consumption at the inlet valve 3 to detect electrical valve malfunctions and/or to draw conclusions about a water flow in the inlet valve 3.

If at least one of these processes detects a valve malfunction at the inlet valve 3, the data processing system 9 triggers at least one damage limitation step.

Such a step can be, for example, triggering a repeated valve closing process on the inlet valve 3 and/or prevent further opening of the inlet valve 3, for example until the next service appointment, and/or adapting a flushing time of the water consumer system 10 to a detected flow of fluid through the fluid supply line 2. The step or steps taken to limit the damage are incorporated as control data in the operating parameters of the water consumer system 10 mentioned at the outset, stored by the water consumer controller 8, and included in further analyses by the data processing system 9.

Additionally or alternatively, the data processing system 9 can send at least one message to a device operator, a plumber, a building management system, and/or a cloud. This message can contain information and/or data on the presence of an obstruction and/or other malfunction in the water consumer system 10. The message can also contain specific instructions at this point, such as instructions for removing the obstruction and/or for checking the drainage and/or for changing a water seal on the water consumer system 10.

Furthermore, the data processing system 9 preferably transmits a signal to a main shut-off valve. As a result of this signal, the water supply to the water consumer system 10 is shut off if the inlet valve 3 does not close.

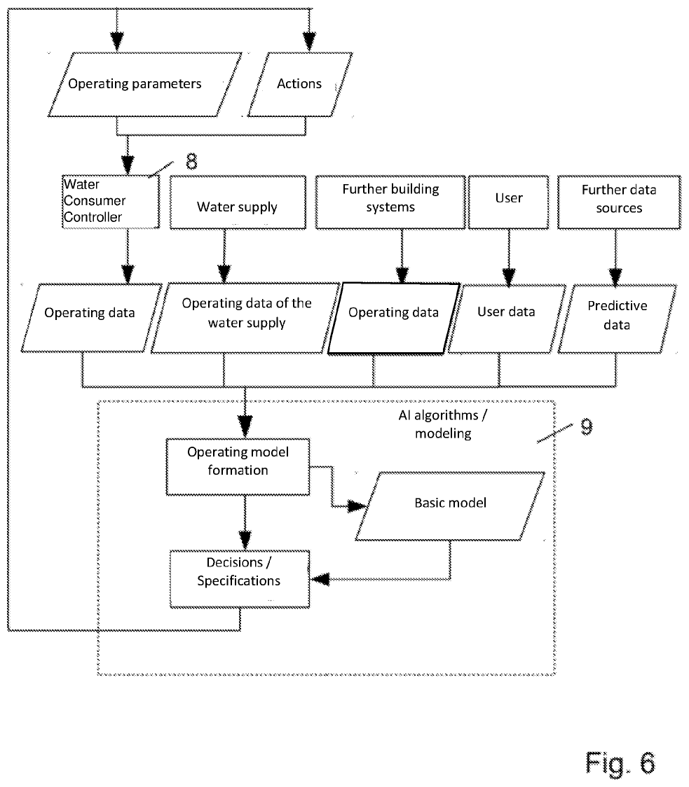

FIG. 6 shows a flow diagram of processes in an embodiment of a water consumer system 10 according to an embodiment of the invention, which can be used to save water. The water consumer system 10 shown in FIGS. 1 and 2, to which reference is made below, or a similar water consumer system can again be used as the water consumer system 10.

In the method shown in FIG. 6 and carried out in the water consumer system 10, operating parameters of the water consumer system 10 are captured and/or stored by a water consumer controller 8 continuously or at predetermined time intervals. Such operating parameters can, for example, be a flushing volume in one or more toilet bowls of the water consumer system 10 and/or a sensitivity of at least one sensor used in the water consumer system 10 and/or a maximum cycle time of the water consumer system 10 and/or a flow through the water consumer system 10 and/or a hybrid mode of the water consumer system 10 and/or a water saving program set in the water consumer system 10 and/or actions carried out in the water consumer system 10, such as opening and/or closing at least one inlet valve 3 of the water consumer system 10 and/or a cleaning procedure lock and/or switching off of a water supply to the water consumer system 10 and/or performing a thermal disinfection on the water consumer system 10 and/or activating lighting in the water consumer system 10 and/or other product-specific actions in the water consumer system 10.

The captured and/or stored operating parameters and actions are processed in a data processing system 9.

The water consumer controller 8 is coupled to the at least one HF motion sensor 5 to detect uses of the water consumer system 10, and to the inlet valve 3 to trigger a water consumer water process (e.g. a flush); the latter can be a solenoid valve, for example.

In the exemplary embodiment shown, the water consumer controller 8 is, unlike in FIGS. 1 and 2, connected to the data processing system 9 formed separately from the water consumer controller 8, which in other embodiments of the invention, as can be seen in FIGS. 1 and 2, can also be part of the water consumer controller 8.

In the exemplary embodiment shown in FIG. 6, the water consumer controller 8 transmits operating data, which can contain, for example, data on water consumption in the water consumer system 10, flow data, data on water pressure in the water consumer system 10, data on a chronological profile of water consumption, flow rate and/or water pressure in the water consumer system 10 and/or on the user frequency of the water consumer system 10, to the data processing system 9.

In the example of FIG. 6,
operating data from a water supply of the water consumer system 10, which can contain data on water pressure, flow rate and/or their respective chronological profile, and/or
operating data of a further building system, such as a light controller and/or a door controller, which can contain, for example, access data from door controllers and/or data from motion or presence detectors of the light controller, and/or
user data from users using the water consumer system 10 and/or the building in which the water consumer system 10 is located, such as data on presence, age, gender, mood and/or user feedback from users, and/or
data from other data sources, such as at least one transit timetable, at least one flight schedule, at least one cleaning schedule, at least one game time, opening times and/or data of at least one weather forecast, from which predictive data is created is/are transmitted to the data processing system 9 in addition to the operating data from the water consumer controller 8.

The data processing system 9 uses artificial intelligence algorithms and at least one modeling function for the further processing of the transmitted data.

In the exemplary embodiment shown in FIG. 6, the data processing system 9 creates an operating model by establishing a correlation between the operating data transmitted from the different sources, establishes interactions between various elements, such as between the water supply and water consumers of a water consumer system in which the water consumer system 10 is integrated, and recognizes and predicts usage scenarios.

Such usage scenarios can, for example, be classified by the data processing system 9 into normal operation with occasional use of the water consumer system 10, a temporary high frequency of use of the water consumer system 10, for example during an intermission in a theater, a standby period when the water consumer system 10 is not being used, a cleaning or service operation, or other application-specific scenarios.

The data processing system 9 preferably already contains a basic model of the installation for describing the water supply, the water consumers of the water consumer system, the further building systems, the influence of the predictive data, the users, and the interactions between these elements. This model can preferably be further developed by the data processing system 9 continuously or step by step, and thereby improved.

From the operating model and the basic model, decisions and/or proposals are preferably created by the data processing system 9 which, for example, relate to or include predicting usage situations and/or optimizing the operating parameters, such as optimizing the consumption of water and/or other consumed supplies of the water consumer system 10, optimizing the user experience of users of the water consumer system 10, and/or optimizing service of the water consumer system 10, and/or triggering actions on the water consumer system 10, and/or outputting at least one piece of information to the user and/or to a building management and/or a plumber.

The decisions and/or suggestions are included as control data in the operating parameters of the water consumer system 10 mentioned at the outset, stored by the water consumer controller 8, and included in further analyses by the data processing system 9.

The exemplary embodiments explained above can also be combined with each other.

According to embodiments of the present invention, malfunctions in the at least one HF motion sensor 5 can also be detected. In some cases, different malfunctions in the HF motion sensor 5 can lead to the same or similar effects. If, for example, the HF motion sensor 5 does not detect water flowing during a water consumer water process, this can be due to the following causes:
complete obstruction, whereby the HF motion sensor 5 does not detect any motion because it is “blind,”
malfunction in the inlet valve 3 or electronics malfunction resulting in the inlet valve 3 not opening,
malfunction in the water supply and/or absence of water supply to the water consumer.

A distinction between these situations can be made in the data processing system 9 by combining the signals from the HF motion sensor 5 with one or more of the following additional pieces of information:
at least one pressure sensor 12 in the fluid supply line 2 detects whether the water supply is intact,
at least one flow sensor in or on the fluid supply line 2 detects independently of the at least one HF motion sensor 5 whether water is flowing,
information from other sensors as to whether other sensors have detected a malfunction in the water supply,
plausibility/learning of typical signal processes (for example, a complete obstruction is unlikely immediately after a use is detected)
sensory detection of complete obstruction.

The corresponding situations can be recognized and distinguished from each other in the data processing system 9 on the basis of typical signal profiles in conjunction with data from further sensors with the aid of a classifier and using methods of artificial intelligence.

By combining the data from various sources and methods of artificial intelligence, functions are enabled according to an embodiment of the invention that are not possible with a conventional sensor or are only possible through human decisions and human intervention.

For example, embodiments of the present invention enable the following applications:

For example, a) a flushing volume regulation and/or a pressure warning is possible as follows:

A water consumer system 10 is flushed by opening an inlet valve 3 for a defined time. The flushing time is usually set so that a desired amount of water (flushing volume) flows into the water receptacle 1 at a defined water pressure (nominal pressure, usually 3 bar). The actual flushing volume depends on the actual water pressure and can vary significantly from the desired flushing volume.

A flushing volume which is too low can lead to increased scale formation or bacterial growth in the water seal or in the drain pipe as a result of insufficient replacement of the water seal of the water consumer system 10, and consequently to an obstruction. Too high a flushing volume unnecessarily increases water consumption.

If the water pressure is low, it may not be possible to achieve adequate replacement of the water seal even by extending the flushing time. This can quickly lead to obstruction.

By networking the water consumer flush system, for example via a wireless or mesh data transmission network, such as Bluetooth or Bluetooth mesh, with the pressure sensor 12 or a flow sensor, or by integrating the pressure sensor 12 or a flow sensor directly into the flush system of the water consumer system 10, the flushing time can be adjusted as a function of the actual water pressure or the flow rate, so that the flushing volume can be set much more precisely (flushing volume regulation).

If the water pressure or flow falls below a certain minimum for a certain time, a diagnosis message can be triggered to inform a responsible person about the increased risk of obstruction and to initiate appropriate measures.

Furthermore, b) an obstruction or risk of obstruction can be recognized and reported as follows:

In the event of a complete or partial obstruction of the fluid outlet 4, fluid accumulates in the water receptacle. In this situation, the at least one HF motion sensor 5 does not recognize a use, and the water consumer controller 8 also does not initiate any water consumer water process until the obstruction is cleared. This situation is usually only recognized by users or cleaning staff after complete obstruction, and then leads to complaints and/or service calls.

The at least one HF motion sensor 5, in combination with the water consumer controller 8 and the data processing system 9 connected to it, effects an evaluation of the flow and drainage behavior in the water consumer system 10 during and after the water consumer water process (e.g. flushing). In this way, when “no drainage” is detected, it is recognized that there may be a complete obstruction, and when “changed drainage behavior” is detected, it is recognized that there may be a beginning obstruction. By means of a trend analysis carried out in the data processing system 9, which is carried out over a longer period of time, a beginning obstruction can thus be predicted in good time.

A complete obstruction of one or more toilet bowls of the water consumer system 10 can also be detected by sensors by evaluating sensor signals from the at least one HF motion sensor 5 or another sensor, as explained above under point a).

To assess the risk of obstruction, the data processing system 9 can also use additional data, if available, such as the water quality, such as the lime content of the water, the flow rate in the wastewater disposal system, information about the gradient of wastewater lines, or the given temperature. All of these factors can, for example, influence scale formation and bacterial growth and thus the risk of obstruction.

If a complete or partial obstruction is detected, a diagnostic message can be output by means of the data processing system 9.

In addition, it is c) possible to carry out an expanded valve diagnosis of the water consumer system 10 as follows:

Inlet valves 3 in the form of solenoid valves are used to control the water flow for a water consumer water process, e.g. flushing toilet bowls, and other electronic products in the water sector. As electronic components, solenoid valves are always a weak point in the system due to their limited service life, for example due to contamination. Defective solenoid valves can lead to a functional failure of the water consumer system 10 in which no water consumer water process is carried out, and/or can lead to continuous operation of the water consumer system 10 if they do not perform a closing function.

In contrast, embodiments of the present invention enable valve diagnosis of the inlet valve 3.

The at least one HF motion sensor 5 can detect the flowing and draining fluid in the event of a water consumer water process (e.g. a flush). It can thus be recognized with the water consumer system 10 according to an embodiment of the invention whether water is flowing during a flush and whether the water flow stops again after the flush. Through a combination with data from other networked sensors, such as pressure sensor(s) 12 and/or flow sensor(s) in the fluid supply line 2, and/or a detection of the flow behavior in the drain of the water consumer system 10, it is possible in embodiments of the present invention to distinguish between a valve malfunction and situations such as a use directly after a flush, a cleaning, and a shut-off water supply, among other things. For this purpose, rules and methods of artificial intelligence, such as learning typical usage situations, can be used by the data processing system 9.

In the event a valve malfunction is detected, the data processing system 9 can trigger a diagnostic message. If the malfunction leads to a permanent flow of water, the water supply of the affected area-such as a room—can be shut off in cooperation with a main shutoff valve, for example via a wireless or mesh data transmission network 14, such as Bluetooth or Bluetooth mesh.

Finally, d) embodiments of the present invention allow for the possibility of a usage profile analysis proceeding as follows, and/or the application of the water-saving algorithms described as follows:

A standard function of sensors in the prior art is a flush after each use. For installations with high user frequency, such as in public buildings, stadiums, etc., water-saving programs can be implemented in known sanitary products that reduce the number of flushes in certain operating situations. The rigid controls of these operating modes mean that these programs do not come into effect in many installations, because, for example, the criteria of a stadium mode are not met despite high user frequency, or the ease of use is unnecessarily restricted, so that, for example, fewer flushes are performed despite low user frequency.

According to embodiments of the present invention, however, an analysis of the actual usage profile of a water consumer system 10 is performed. In this case, typical usage scenarios of the water consumer system 10 are recognized over a longer period of time, times of high usage of the water consumer system 10 are identified, and suitable and effective water-saving programs are activated for the given situation.

In addition to the operating data of the at least one HF motion sensor 5, the analysis of the usage profiles can also include further data from other products, such as data from other sanitary products in the room, which provide a measure of how often the room is used, schedules/opening times of a building, theater schedules and/or airport flight schedules, etc., in order to predict times of high traffic and to activate water-saving programs tailored to the given situation. In this way, a flush interval and the flushing volume can be adapted to an expected number of users, and a cleaning flush with a high flushing volume can be triggered at suitable times.

Intervention by the respective user or building operator is possible in principle, but not necessary for embodiments of the present invention to function.

With the aid of embodiments of the present invention it is also possible to optimize the cleaning cycles of the water consumer system 10. For example, consumables such as soap or towels can be replenished before anticipated traffic, and cleaning can be carried out after a use frequency.

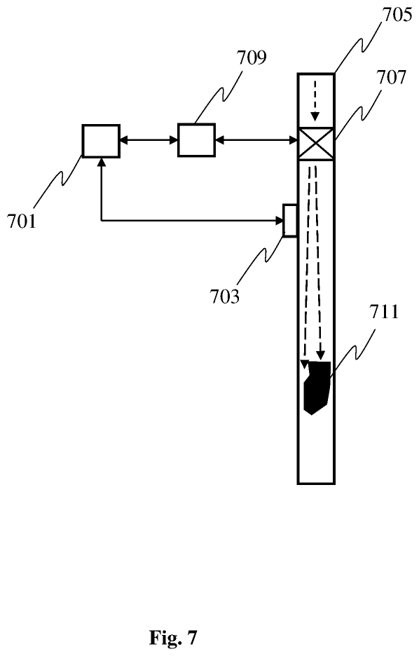

According to a further example, the water consumer system may operate to provide different flush cleaning modes dependent on the severity of a detected and/or monitored blockage in pipework associated with one or more water consumers. FIG. 7 shows an example system in which a blockage sensor 701 senses water flow (indicated by the broken arrows) using an HF motion sensor 703. The HF motion sensor 703 is attached to pipework 705 (e.g. a fluid outlet) associated with one or more water consumers (not shown). The pipework 705 has a water valve 707 that is controllable by a data processing system 709.

The data processing system 709 is adapted and/or trained to control, for example, one or more of i) the volume of water flowing through the pipework 705, ii) the water pressure of water flowing through the pipework 705, iii) one or more periods of time in which water may flow through the pipework 705, iv) one or more intervals at which water may or may not flow through the pipework 705.

The data processing system 709 may have at least one data processing block with machine learning (e.g. unsupervised machine learning), or comprising an artificial neural network, and/or containing an expert system.

According to one example, the blockage sensor 701 may provide pipework blockage signals indicating how severe a blockage 711 is in the pipework 705 based on operation of the HF motion sensor 703.

According to one example, the blockage sensor 701 may provide pipework blockage signals indicating how a blockage in the pipework 705 is changing over time based on operation of the HF motion sensor 703.

According to one example, the blockage sensor 701 may provide pipework blockage signals indicating how a blockage has improved (i.e. cleared) in the pipework 705 over time based on operation of the HF motion sensor 703.

In the example of a toilet bowl, the blockage 711 may be several meters away from the actual toilet bowl or may be close to the toilet bowl trap. Therefore, in this example, the flush cleaning mode may operate to cause a minimum number (e.g. one or two) of flush cycles to occur in an attempt to remove the blockage. This may therefore reduce the risk of water overflowing via the toilet bowl if the blockage is located near the toilet trap.

According to one example, there may be multiple flush cleaning modes that operate by controlling the flow rate, and period of water flow. A first flush cleaning mode may operate at a high flow rate for a single period of time. A second flush cleaning mode may operate at a medium flow rate for a single period of time. A third flush cleaning mode may operate at a low flow rate for a single period of time. Each of these flush cleaning modes may be modified according to the amount of time (or period) that the water is flowing. For example, the first mode may have a first sub-mode in which the flow time is a long period.

Alternatively, the first flush cleaning mode may have a second sub-mode in which the flow time is a medium period. Alternatively, the first flush cleaning mode may have a third sub-mode in which the flow time is a short period.

As a further example a fourth flush cleaning mode may operate at a high flow rate for multiple periods of time. That is, the water flow may be turned on and off at defined intervals. The intervals may be the same or may be different. A fifth flush cleaning mode may operate at a medium flow rate for multiple periods of time. That is, the water flow may be turned on and off for defined intervals. The intervals may be the same or may be different. A sixth flush cleaning mode may operate at a low flow rate for multiple periods of time. That is, the water flow may be turned on and off for defined intervals. The intervals may be the same or may be different. A combination of different (high, medium, low) flush rates may be used at the same or different time intervals for further flush cleaning modes.

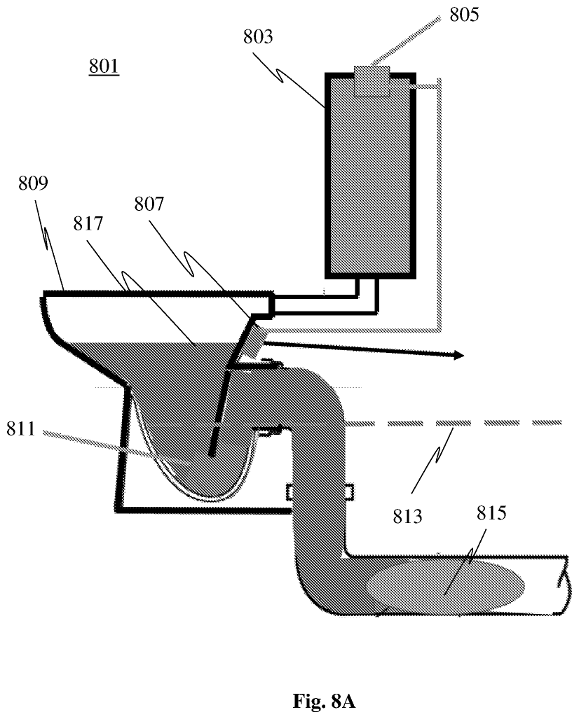

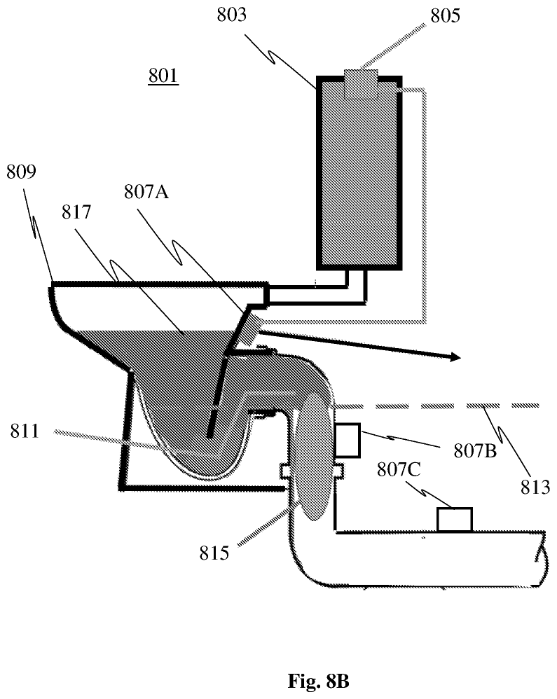

FIG. 8A shows an example toilet system 801 with a cistern 803 filled with water. An electronic flush controller 805 (non-touch, for example) may be activated to flush the toilet 801. For example, the flush controller 805 may be integrated with a BT5 mesh controller.

In this example, a single HF motion sensor 807 is used to monitor the water level in the toilet bowl 809. The HF motion sensor 807 is in communication with the flush controller 805, and a facility management system (e.g. a building management system (BMS)) as indicated by the arrow. In the toilet bowl is a pan trapway area 811. During a normal, non-obstructed, flush operation the water level in the toilet bowl 809 rises to a normal water level 813. However, when an obstruction 815 is present, the water level rises to a higher level 817 than that during a normal flushing action due to the obstruction reducing the flush discharge flow rate. In this obstruction scenario, the HF motion sensor 807 detects the increase in the water level in the toilet bowl 809. This increased (abnormal) water level detection causes the HF motion sensor 807 to provide a signal output (indicated by the arrow or connection to the flush controller). This signal output may be used to deactivate the flush controller to prevent any further flush operations to avoid any water overflow. Also, the signal output may be used to deactivate the inlet valve and/or send an error message and/or service message to a facility management system. Although FIG. 8A shows the obstruction 815 in the connected pipework of the toilet system 801, it will be understood that the obstruction may also be in the trapway area 811 or in the sump area (i.e. between the trapway 811 and the connected pipework). Regardless of where the obstruction is located, the water level in the toilet bowl will increase abnormally during a flush operation to enable the HF motion sensor to detect that an obstruction exists.

As a further example, as shown in FIG. 8B, two or more HF motion sensors may be used by the water consumer system where the data obtained from those HF motion sensors is analysed to determine the severity of a blockage in the water consumer system. For example, the system may use HF motion sensors 807A and 807B. As another example, the system may use HF motion sensors 807A and 807C. As a further example, the system may use HF motion sensors 807B and 807C. As a further example, the system may use HF motion sensors 807A, 807B and 807C. Further HF motion sensors (not shown) may also be used.

As an example, a detection by HF motion sensor 807A of a rise in the water level may cause one or more of deactivation of the flush controller to avoid any further flush operations to avoid any overflow, deactivation of the inlet valve and/or sending an error message and/or a service message to a facility management system. Whereas, detection of early stages of an obstruction at the back of the toilet trap due to a detection in flush discharge flow rate decrease by HF motion sensor 807B may cause a warning message and/or a service message to be sent to a facility management system. The second HF motion sensor 807B may also be positioned so that it is located just above the normal water level 813. The third HF motion sensor 807C may be located in the connected pipework to detect a reduction in flush discharge flow rates and so may indicate that an obstruction is just starting to form in the connected pipework downstream of the HF motion sensor and so may only cause a warning message to be sent to a facility management system. That is, depending on which of two or more HF motion sensors are detecting a reduction in flush discharge flow rate and/or an increase in water level, a remedial action may be generated.

The examples described herein with reference to FIGS. 8A and 8B may also apply to other water consumers including urinals, sinks, cisterns, showers, and baths.

1. (canceled)

2. (canceled)

3. A water consumer system comprising a water consumer that comprises a water receptacle, the water consumer system further comprising a fluid inlet with an inlet valve, a fluid outlet, at least one HF motion sensor for detecting fluid motion provided on the water receptacle and/or at the fluid outlet and a water consumer controller coupled with the at least one HF motion sensor and the inlet valve, wherein the water consumer controller comprises a data processing system and/or is connected to a data processing system, which is arranged to i) obtain data captured by the HF motion sensor, ii) to evaluate the data arithmetically and iii), based on the evaluated data, identify at least one of the following malfunctions:
that the fluid outlet is obstructed;
that the fluid inlet is malfunctioning;
that the inlet valve is malfunctioning; and
that there is a malfunction of the at least one HF motion sensor,
wherein the data processing system comprises at least one data processing block that is machine-learning and/or comprises an artificial neuronal net and/or includes an expert system, wherein the water consumer is one of a sink, toilet bowl, cistern, shower, and bath.

4. The water consumer system of claim 3, wherein the water consumer system comprises an error message and/or service notification output unit coupled with the data processing system.

5. The water consumer system of claim 3, wherein the data processing system is arranged to identify at least one of a predefined water consumer usage situation and frequency of use based on the evaluated data, and adjust at least one of an opening time, an opening position and an opening frequency of the inlet valve based thereon during at least one subsequent water consumer flushing process.

6. The water consumer system of claim 3, wherein the water consumer system comprises at least one additional water consumer, where at least one additional sensor is provided, wherein the data processing system is coupled with the at least one additional sensor and is arranged to arithmetically evaluate the data captured by the at least one additional sensor and received by the data processing system and to include the data into the detection and/or prevention of at least one of the malfunctions.

7. The water consumer system of claim 6, wherein the water consumers are connected with each other via a meshed and/or a wireless local data transmission network.

8. A method for operating a water consumer system comprising a water consumer that comprises a water receptacle, the water consumer system further comprising a fluid inlet with an inlet valve, a fluid outlet, at least one HF motion sensor for detecting fluid motion provided on the water receptacle and/or at the fluid outlet and a water consumer controller coupled with the at least one HF motion sensor and the inlet valve, wherein the water consumer controller comprises a data processing system and/or is connected to a data processing system, which i) obtains data captured by the at least one HF motion sensor, ii) evaluates the data arithmetically and, iii) based on the evaluated data, recognizes when there is one of the following malfunctions:
that the fluid outlet is obstructed;
that the fluid inlet is malfunctioning;
that the inlet valve is malfunctioning; and
that there is a malfunction of the at least one HF motion sensor,
wherein the data processing system comprises at least one data processing block that is machine-learning and/or comprises an artificial neuronal net and/or includes an expert system, and wherein the water consumer is one of a sink, toilet bowl, cistern, shower, and bath.

9. The method of claim 8, wherein a fluid pressure is captured by means of at least one pressure sensor and/or a fluid flow is captured by means of at least one flow sensor in the fluid inlet, the captured fluid pressure and/or the captured fluid flow is/are transmitted to the data processing system, the data processing system arithmetically evaluates the captured fluid pressure and/or the captured fluid flow along with the data obtained by the at least one HF motion sensor and, based on the evaluated data, recognizes when there is at least one of the following malfunctions and/or triggers at least one action in order to prevent at least one of the following malfunctions:
that the fluid outlet is obstructed;
that there is a pressure fluctuation in a waste water system connected to the water consumer system;
that the pressure in the fluid inlet has dropped below a minimum pressure value or exceeded a maximum pressure value; and
that the fluid inlet or the inlet valve is malfunctioning.

10. The method of claim 8, wherein the inlet valve opens for a predefined time if draining fluid is detected by the HF motion sensor.

11. The method of claim 8, wherein the data processing system recognizes that the fluid outlet is blocked and/or the fluid inlet is faulty, if no draining fluid is detected by the HF motion sensor even though the inlet valve is open and/or it is detected by means of the at least one HF motion sensor that at least a lower area within the water receptacle is filled with standing fluid.

12. The method of claim 11, wherein the data processing system recognizes whether the fluid outlet is blocked or the fluid inlet is faulty, if no draining fluid is detected by the at least HF motion sensor even though the inlet valve is opened and fluid pressure has been captured by the at least one pressure sensor and/or fluid flow has been captured by the at least one flow sensor and/or it is detected by means of the at least one HF motion sensor that at least a lower area within the water receptacle is filled with standing fluid.

13. The method of claim 9 or 10, wherein the data processing system recognizes that the fluid outlet is partially blocked and/or the fluid inlet is faulty, if it is detected by the at least one HF motion sensor that there is a delayed drainage of fluid from the water receptacle even though the inlet valve is opened.

14. The method of claim 13, wherein the data processing system recognizes, whether the fluid outlet is partially blocked or the fluid inlet is faulty when it is detected by the at least one HF motion sensor that fluid drains from the water receptacle with a delay even though the inlet valve is opened and fluid pressure has been captured by the at least one pressure sensor and/or fluid flow has been captured by the at least one flow sensor.

15. The method of claim 9, wherein a respective opening time of the inlet valve is adjusted to the respective fluid pressure and/or the respective fluid flow in the fluid inlet by the water consumer controller.

16. The method of claim 8, wherein the data processing system recognizes that the fluid inlet is faulty, if the at least one HF motion sensor detects no fluid flow and/or a permanent fluid flow and/or a fluid flow beneath a fluid flow threshold value.

17. The method of claim 8, wherein the water consumer system comprises an error message and/or service notification output unit coupled with the data processing system and that the data processing system puts out a service notification to the error and/or service notification output unit when it recognizes at least one of the malfunctions.

18. The method of claim 8, wherein the data processing system recognizes that there is a pressure fluctuation in the waste water system connected to the water receptacle if a series of consecutive faulty water processes on the water consumer system results from the process of the data of the at least one HF motion sensor and/or a signal pattern of the data of the at least one HF motion sensor corresponds to a characteristic fluctuation of the fluid level in the fluid outlet.

19. The method of claim 8, wherein when the data processing system recognizes that there is a pressure fluctuation in a waste water system connected to the water consumer system, the water consumer controller changes a sensitivity of the at least one HF motion sensor and/or when a signal pattern of the data of the at least one HF motion sensor corresponds to a characteristic fluctuation of the fluid level in the fluid outlet, does not initiate a water process.

20. The method of claim 8, wherein the data processing system comprises at least one data processing block, which is machine-learning and/or works based on an artificial neuronal net and/or is an expert system.

21. The method of claim 8, wherein the water consumer system comprises at least one additional water consumer, where at least one additional sensor is provided, wherein the data processing system is coupled with the at least one additional sensor and also arithmetically evaluates the data received by the at least one additional sensor, wherein at least one water processing time and/or blockage in an outlet and/or pressure fluctuation in a waste water system and/or defect of an inlet device of the at least one additional water consumer determined thereby, is included in the detection of at least one of the malfunctions.

22. The method of claim 21, wherein the water consumers communicate with each other via a meshed and/or a wireless local data transmission network.

23. The method of claim 8, wherein there is a malfunction of at least one of the at least one HF motion sensor if the data processing system does not receive data from at least one of the at least one HF motion sensor or the data of at least one of the at least one HF motion sensor received by the data processing system are not processible by the data processing system and/or at least one of the at least one HF motion sensor issues at least one service signal.

24. A water consumer system comprising at least one urinal, the water consumer system further comprising a fluid inlet with an inlet valve, a fluid outlet, at least one HF motion sensor for detecting fluid motion provided on the urinal and/or at the fluid outlet and a water consumer controller coupled with the at least one HF motion sensor and the inlet valve, wherein the water consumer controller comprises a data processing system and/or is connected with a data processing system, which is arranged to i) obtain data captured by the HF motion sensor, ii) evaluate the data arithmetically, and, iii) based on the evaluated data, detect an obstruction, and to control one or more of the inlet valve and a flush controller based on the evaluated data to a) clear or alleviate the obstruction or b) avoid an overflow.

25. A water consumer system comprising a water consumer that comprises a water receptacle, the water consumer system further comprising a fluid inlet with an inlet valve, a fluid outlet, at least one HF motion sensor for detecting fluid motion provided on the water receptacle and/or at the fluid outlet and a water consumer controller coupled with the at least one HF motion sensor and the inlet valve,
wherein the water consumer is one of a sink, toilet bowl, cistern, shower, and bath,
wherein the water consumer controller comprises a data processing system and is connected with a data processing system, which is arranged to i) obtain at least retrieve and data captured by the HF motion sensor, ii) evaluate the data arithmetically and iii), based on the evaluated data, detect an obstruction,
and, upon detection of an obstruction, perform at least one of the following actions:
activate one or more flush cleaning modes dependent on the severity of the detected obstruction;
close the inlet valve;
deactivate operation of a flush controller; and
send an error or service message.

26. The water consumer system of claim 3, wherein the water consumer system further comprises at least one pressure sensor and/or at least one flow sensor in the fluid inlet and/or is coupled with at least one pressure sensor and/or at least one flow sensor in the fluid inlet via a meshed data transmission network, wherein the data processing system is further arranged to i) obtain data captured by at least one of the pressure sensor and the flow sensor, ii) evaluate the data arithmetically and iii) based on the evaluated data, identify at least one of the following malfunctions:
that the water consumer outlet is obstructed;
that there is a pressure fluctuation in a wastewater system connected to the water consumer system;
that pressure in the fluid inlet has dropped below a minimum pressure value, or has exceeded a maximum pressure value; and
that the fluid inlet or the inlet valve is malfunctioning.

27. The water consumer system of claim 3, wherein the inlet valve is arranged to open for a predefined time if draining fluid is detected by the HF motion sensor.
